(19) United States
(12) Patent Application Publication
(10) Pub. No.: US 2016/0131985 A1
(43) Pub. Date: May 12, 2016

(54) ELECTROPHOTOGRAPHIC PHOTOSENSITIVE MEMBER, PROCESS CARTRIDGE, AND ELECTROPHOTOGRAPHIC APPARATUS

(71) Applicant: CANON KABUSHIKI KAISHA, Tokyo (JP)

(72) Inventors: Masato Tanaka, Tagata-gun (JP); Masataka Kawahara, Mishima-shi (JP); Tsutomu Nishida, Mishima-shi (JP)

(21) Appl. No.: 14/928,769

(22) Filed: Oct. 30, 2015

(30) Foreign Application Priority Data
Nov. 11, 2014 (JP) 2014-228873
Nov. 19, 2014 (JP) 2014-234937

(51) Int. Cl. G03G 15/00

(52) U.S. Cl. CPC G03G 5/0436; G03G 5/0614; G03G 5/0696

(57) ABSTRACT

Provided is an electrophotographic photosensitive member, including in the following order: a support; a charge-generating layer; and a charge-transporting layer, in which: the charge-generating layer includes a gallium phthalocyanine crystal in which an organic compound is contained; the organic compound is at least one compound selected from the group consisting of dimethyl sulfoxide, N,N-dimethylformamide, N-methylformamide, N-propylformamide, N-vinylformamide, and N-methylpyrrolidone; a content of the organic compound is 0.1% by mass or more and 1.5% by mass or less with respect to a mass of gallium phthalocyanine in the gallium phthalocyanine crystal; and the charge-transporting layer comprises at least one compound selected from the group consisting of a compound represented by the formula (1), a compound represented by the formula (2), a compound represented by the formula (3), and a compound represented by the formula (4).

### BACKGROUND OF THE INVENTION

1. Field of the Invention

The present invention relates to an electrophotographic photosensitive member, and a process cartridge and an electrophotographic apparatus each including the electrophotographic photosensitive member.

2. Description of the Related Art

At present, an electrophotographic photosensitive member having a function-separation-type laminate structure in which a photosensitive layer is formed on a support, and the photosensitive layer includes a layer having a charge-generating function (charge-generating layer) and a layer having a charge-transporting function (charge-transporting layer) separated from each other is generally used as an electrophotographic photosensitive member.

With regard to a charge-generating substance having the charge-generating function, an oscillation wavelength of semiconductor laser, which has been frequently used as an image exposing device, is a long wavelength of from 650 nm to 820 nm. Accordingly, development of a charge-generating substance having high sensitivity to light having such a long wavelength has been advanced.

A phthalocyanine pigment is effective as the charge-generating substance having high sensitivity to light over such a long wavelength region. In particular, oxytitanium phthalocyanine and gallium phthalocyanine have excellent sensitivity characteristics, and various crystal forms thereof and modified production methods therefor have been reported heretofore.

In Japanese Patent Application Laid-Open No. H07-331107, there is disclosure of a hydroxygallium phthalocyanine crystal containing a polar solvent. When a polar solvent, such as N,N-dimethylformamide, is used as a transformation solvent, the polar solvent is incorporated into a crystal to yield a crystal having excellent sensitivity characteristics. However, the crystal contrarily involves the following problem. A produced photocarrier is liable to remain on the photosensitive layer and is liable to serve as one kind of memory to cause an electric potential variation, such as a ghost phenomenon.

On the other hand, with regard to a charge-transporting substance having the charge-transporting function, development of a charge-transporting substance having such a high mobility as to enable transportation of a photocarrier produced with a charge-generating substance in a short period of time has been advanced.

In Japanese Patent Application Laid-Open No. 2010-70511 and Japanese Patent Application Laid-Open No. 2004-151666, there are disclosures of a triarylamine-based charge-transporting substance having a terphenyl structure and a charge-transporting substance having an enamine structure.

However, when the photosensitive member is produced by merely selecting and combining the charge-generating substance having high sensitivity and the charge-transporting substance having a high mobility, a ghost phenomenon may occur under the influence of an injection property of a photocarrier between the charge-generating substance and the charge-transporting substance.

### SUMMARY OF THE INVENTION

As described above, various attempts have been made to develop an electrophotographic photosensitive member.

However, the additional alleviation of the deterioration of image quality due to a ghost phenomenon under various environments has been desired in association with an additional improvement in image quality in recent years.

The present invention is directed to providing an electrophotographic photosensitive member that can output an image having less image defects due to the ghost phenomenon not only under a normal-temperature and normal-humidity environment but also under a low-temperature and low-humidity environment as a particularly severe condition, and a process cartridge and an electrophotographic apparatus each including the electrophotographic photosensitive member.

According to one aspect of the present invention, there is provided an electrophotographic photosensitive member, including in the following order:

a support;

a charge-generating layer; and

a charge-transporting layer, wherein:

the charge-generating layer comprises a gallium phthalocyanine crystal in which an organic compound is contained;

the organic compound is at least one compound selected from the group consisting of dimethyl sulfoxide, N,N-dimethylformamide, N-methylformamide, N-propylformamide, N-vinylformamide, and N-methylpyrrolidone;

a content of the organic compound is 0.1% by mass or more and 1.5% by mass or less with respect to a mass of gallium phthalocyanine in the gallium phthalocyanine crystal; and

the charge-transporting layer includes at least one compound selected from the group consisting of a compound represented by the formula (1), a compound represented by the formula (2), a compound represented by the formula (3), and a compound represented by the formula (4):

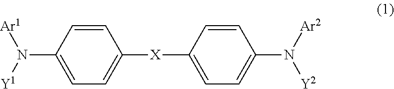

in the formula (1):

Ar¹ and Ar² each independently represent a substituted or unsubstituted phenyl group;

X represents a phenylene group;

Y¹ and Y² each independently represent a substituted or unsubstituted phenyl group, a substituted or unsubstituted benzyl group, a 9,9-dimethyl-9H-fluoren-2-yl group, or a group represented by the following formula (A);

a substituent of the substituted phenyl group is an alkyl group having 1 to 4 carbon atoms, a methoxy group, an ethoxy group, a dimethylamino group, a diethylamino group, or a phenyl group; and

a substituent of the substituted benzyl group is a methyl group or an ethyl group,

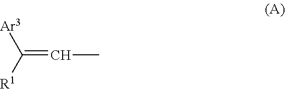

in the formula (A):

Ar³ represents a substituted or unsubstituted phenyl group;

a substituent of the substituted phenyl group is an alkyl group having 1 to 4 carbon atoms, a methoxy group, an ethoxy group, a dimethylamino group, a diethylamino group, or a phenyl group;

R¹ represents a substituted or unsubstituted alkyl group having 1 to 3 carbon atoms; and

a substituent of the substituted alkyl group is an alkyl group having 1 to 4 carbon atoms, a methoxy group, an ethoxy group, a dimethylamino group, a diethylamino group, or a phenyl group,

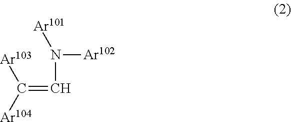

in the formula (2):

Ar¹⁰¹ to Ar¹⁰⁴ each independently represent a substituted or unsubstituted aryl group,

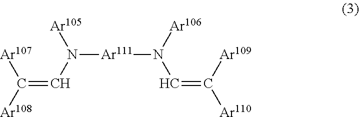

in the formula (3):

Ar¹⁰⁵ to Ar¹¹⁰ each independently represent a substituted or unsubstituted aryl group; and

Ar¹¹¹ represents a phenylene group or a 4,4′-biphenyldiyl group,

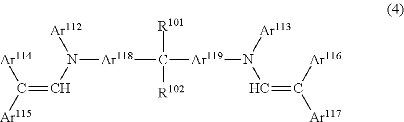

in the formula (4):

Ar¹¹² to Ar¹¹⁷ each independently represent a substituted or unsubstituted aryl group;

Ar¹¹⁸ and Ar¹¹⁹ each independently represent a phenylene group or a 4,4′-biphenyldiyl group; and

R¹⁰¹ and R¹⁰² each independently represent an alkyl group or a phenyl group, or R¹⁰¹ and R¹⁰² represent groups necessary for forming a ring structure by being bonded to each other together with a carbon atom to which R¹⁰¹ and R¹⁰² are bonded.

According to another aspect of the present invention, there is provided a process cartridge, which integrally supports the above-mentioned electrophotographic photosensitive member and at least one device selected from the group consisting of a charging device, a developing device, a transferring device and a cleaning device, and is detachably mountable to a main body of an electrophotographic apparatus.

According to further aspect of the present invention, there is provided an electrophotographic apparatus, including: the above-mentioned electrophotographic photosensitive member; a charging device; an exposing device; a developing device; and a transferring device.

According to the aspects of the present invention, the electrophotographic photosensitive member that can output an image having less image defects due to the ghost phenomenon not only under a normal-temperature and normal-humidity environment but also under a low-temperature and low-humidity environment as a particularly severe condition, and the process cartridge and the electrophotographic apparatus each including the electrophotographic photosensitive member can be provided.

Further features of the present invention will become apparent from the following description of exemplary embodiments with reference to the attached drawings.

### BRIEF DESCRIPTION OF THE DRAWINGS

FIG. 1 is a view for illustrating an example of a schematic configuration of an electrophotographic apparatus including a process cartridge including an electrophotographic photosensitive member of the present invention.

FIG. 2 is a powder X-ray diffraction spectrum of a hydroxygallium phthalocyanine crystal obtained in Preparation Example 1.

FIG. 3 is a powder X-ray diffraction spectrum of a chlorogallium phthalocyanine crystal obtained in Preparation Example 9.

### DESCRIPTION OF THE EMBODIMENTS

Preferred embodiments of the present invention will now be described in detail in accordance with the accompanying drawings.

An electrophotographic photosensitive member of the present invention includes a support, and a charge-generating layer and a charge-transporting layer on the support. The charge-generating layer includes a gallium phthalocyanine crystal in which an organic compound is contained (hereinafter referred to as “organic compound-containing gallium phthalocyanine crystal”). The organic compound contained in the gallium phthalocyanine crystal is at least one compound selected from the group consisting of dimethyl sulfoxide, N,N-dimethylformamide, N-methylformamide, N-propylformamide, N-vinylformamide, and N-methylpyrrolidone. The organic compound-containing gallium phthalocyanine crystal contains the organic compound at a ratio of 0.1% by mass or more and 1.5% by mass or less with respect to the mass of gallium phthalocyanine. It should be noted that when the organic compound-containing gallium phthalocyanine crystal contains two or more kinds of organic compounds, the content ratio of the organic compound is a content ratio based on the total amount of the organic compounds. In addition, the charge-transporting layer contains at least one compound selected from the group consisting of a compound represented by the formula (1), a compound represented by the formula (2), a compound represented by the formula (3), and a compound represented by the formula (4). First, the compound represented by the formula (1) is described.

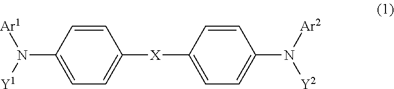

In the formula (1):

Ar¹ and Ar² each independently represent a substituted or unsubstituted phenyl group;

X represents a phenylene group;

Y¹ and Y² each independently represent a substituted or unsubstituted phenyl group, a substituted or unsubstituted benzyl group, a 9,9-dimethyl-9H-fluoren-2-yl group, or a group represented by the following formula (A);

a substituent of the substituted phenyl group is an alkyl group having 1 to 4 carbon atoms, a methoxy group, an ethoxy group, a dimethylamino group, a diethylamino group, or a phenyl group; and

a substituent of the substituted benzyl group is a methyl group or an ethyl group.

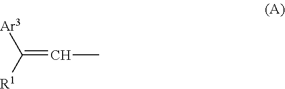

In the formula (A):

Ar³ represents a substituted or unsubstituted phenyl group;

a substituent of the substituted phenyl group is an alkyl group having 1 to 4 carbon atoms, a methoxy group, an ethoxy group, a dimethylamino group, a diethylamino group, or a phenyl group;

R¹ represents a substituted or unsubstituted alkyl group having 1 to 3 carbon atoms; and

a substituent of the substituted alkyl group is an alkyl group having 1 to 4 carbon atoms, a methoxy group, an ethoxy group, a dimethylamino group, a diethylamino group, or a phenyl group.

It is preferred that Y¹ in the formula (1) represent a 9,9-dimethyl-9H-fluoren-2-yl group. Further, it is more preferred that Y¹ and Y² in the formula (1) each represent a 9,9-dimethyl-9H-fluoren-2-yl group.

In addition, it is also preferred that Ar¹ and Ar² in the formula (1) each represent a tolyl group.

Preferred specific examples (Exemplified Compounds) of the compound represented by the formula (1) contained in the electrophotographic photosensitive member of the present invention are shown below. However, the present invention is not limited thereto.

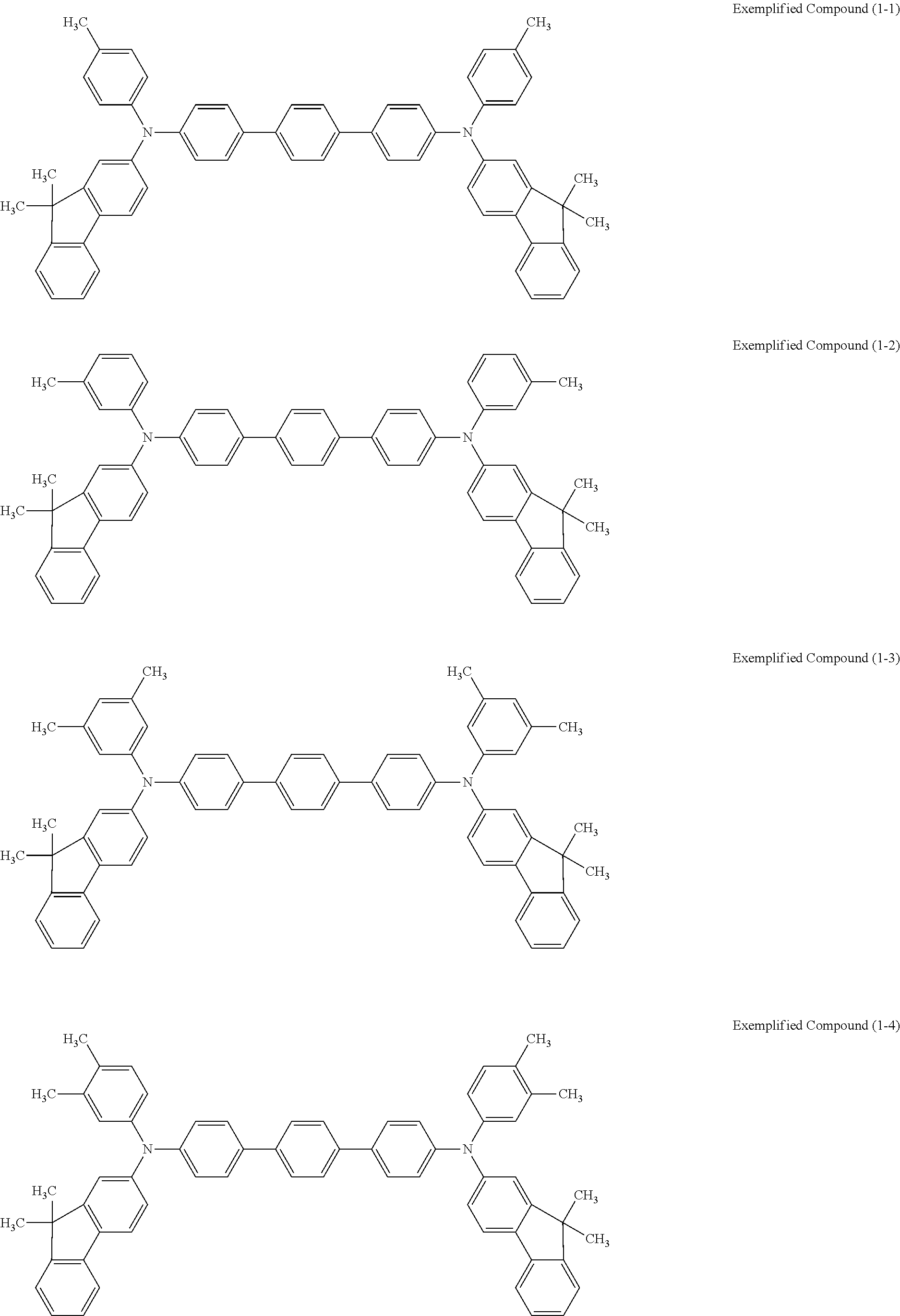

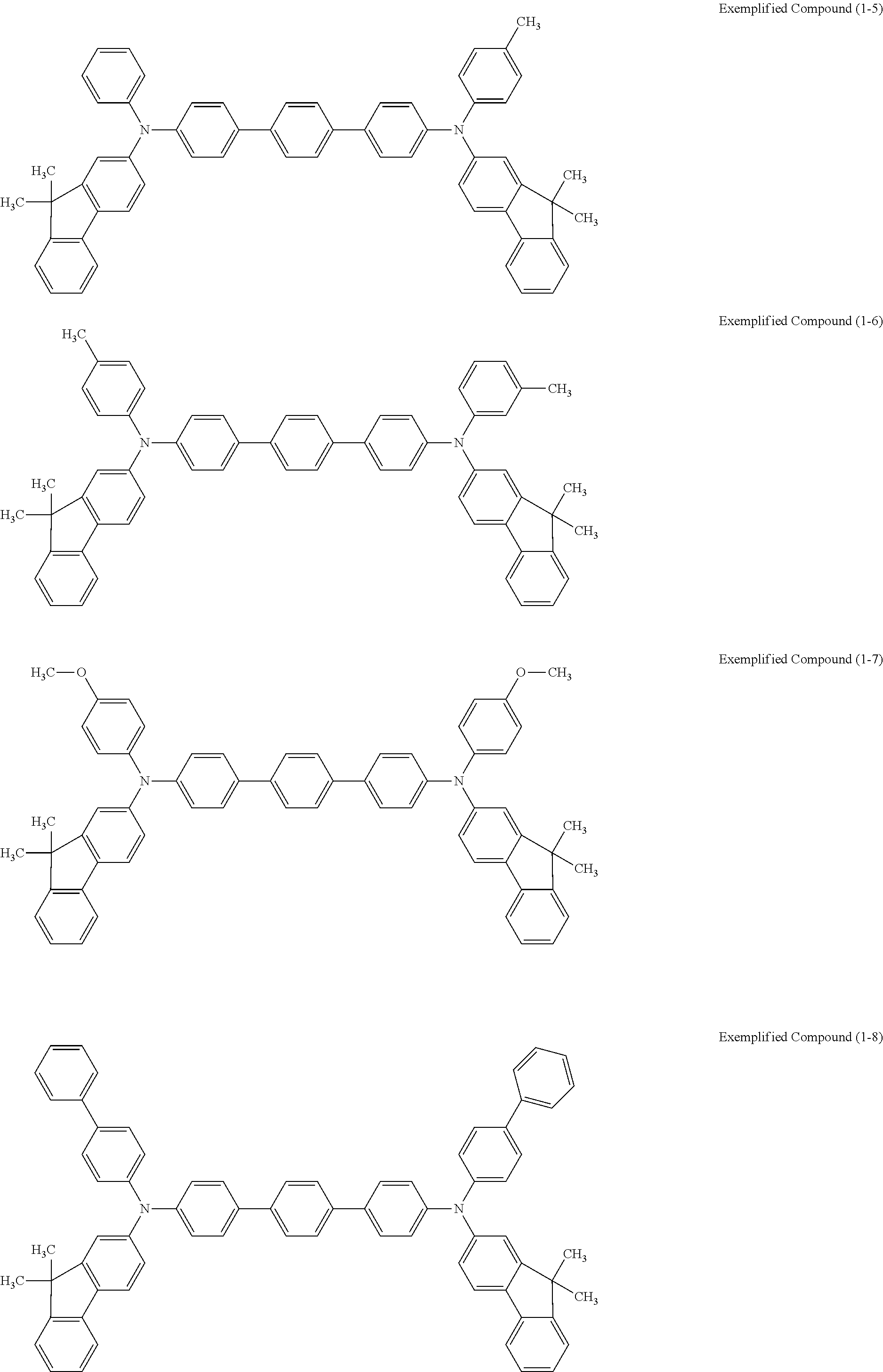

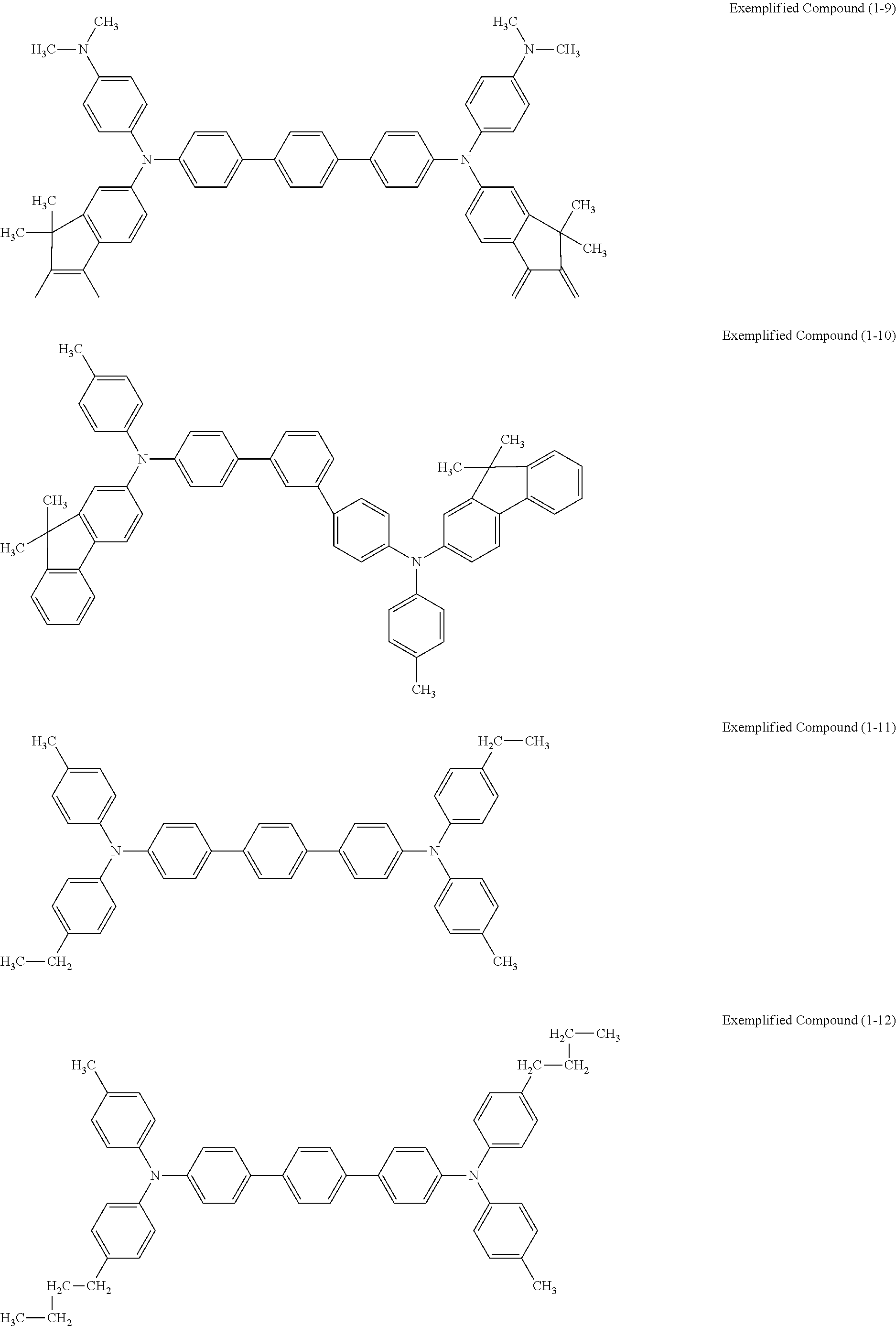

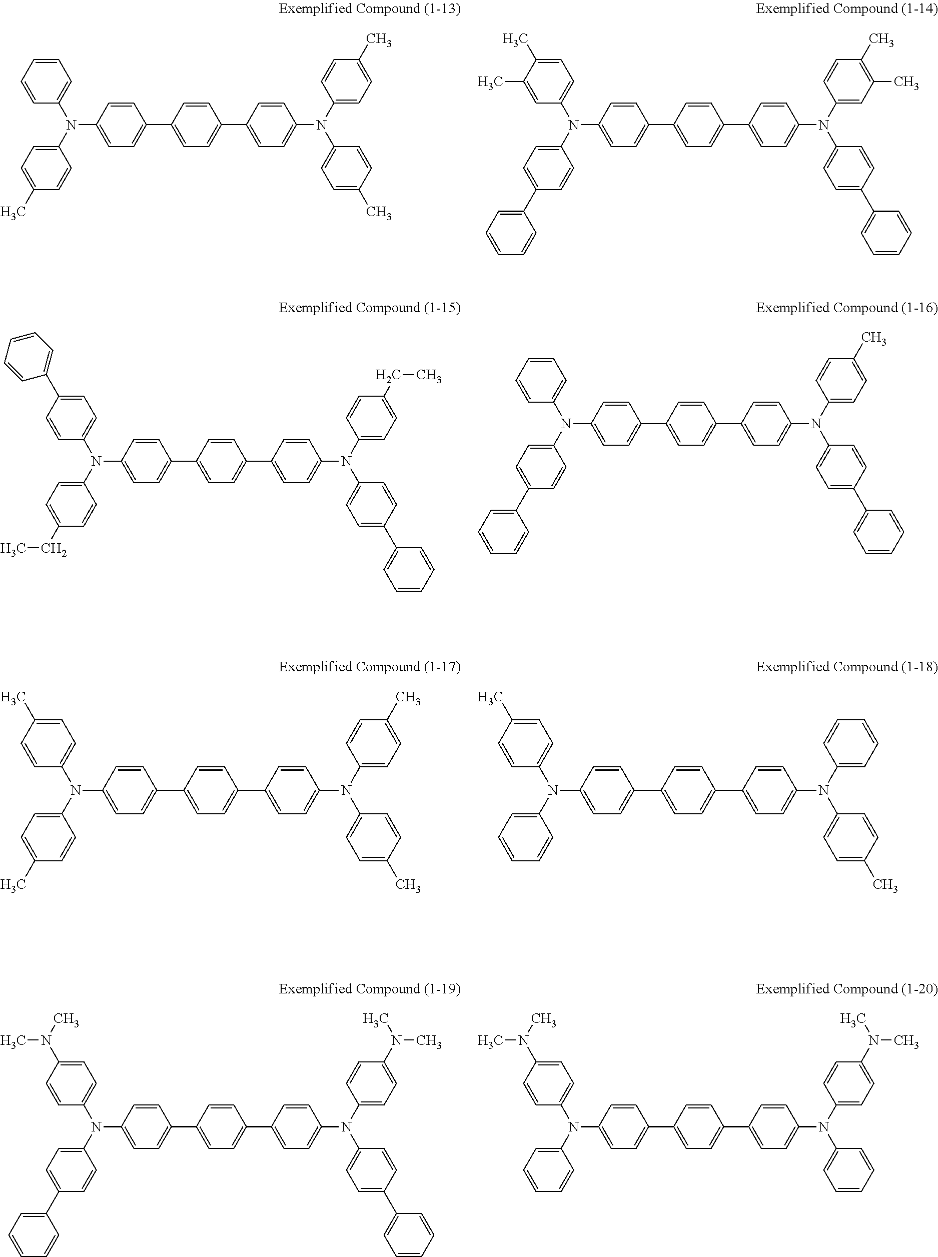

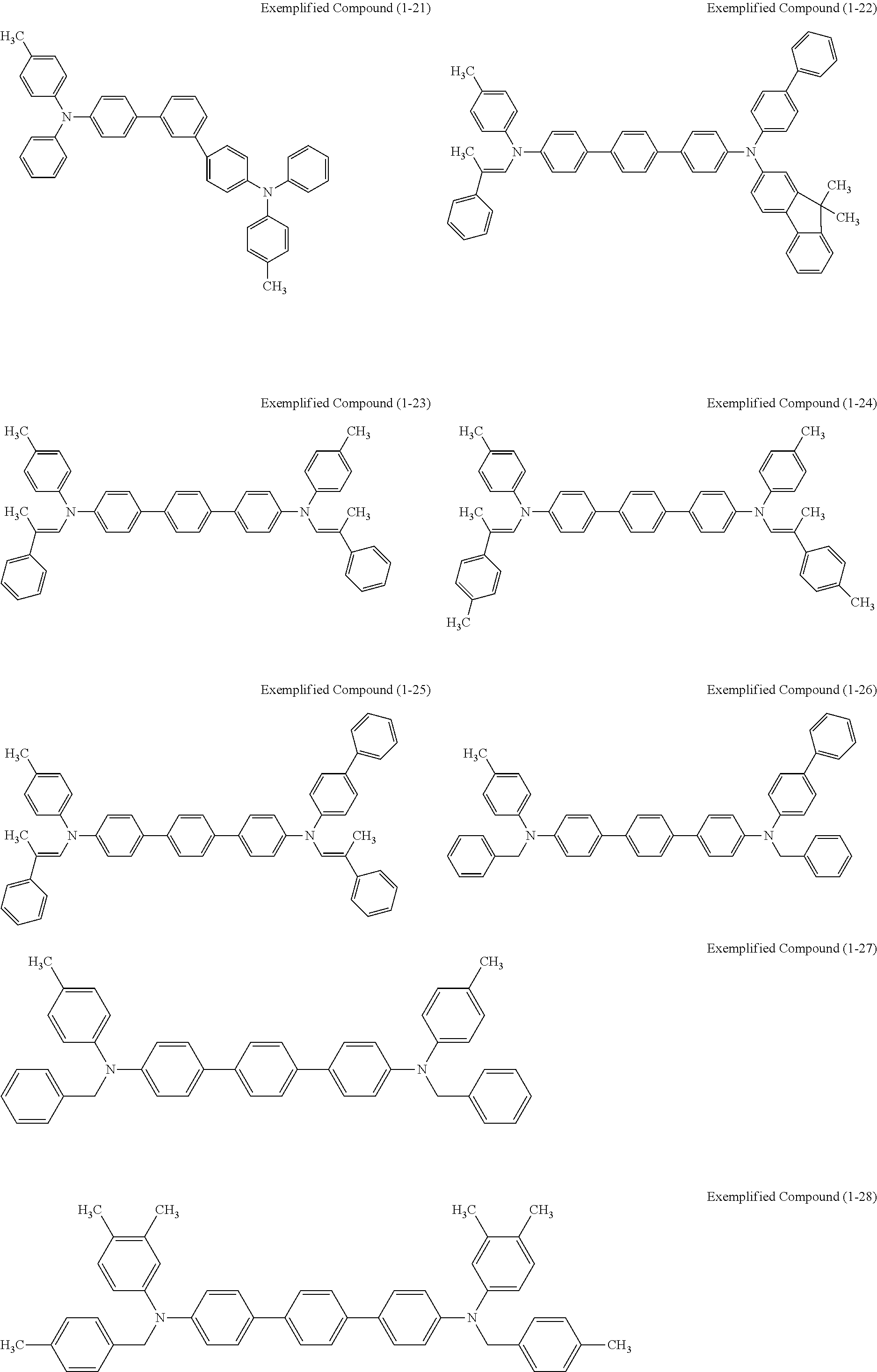

Next, the compounds represented by the formulae (2) to (4) are described.

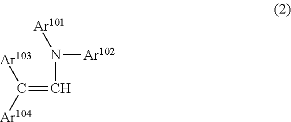

In the formula (2):

Ar¹⁰¹ to Ar¹⁰⁴ each independently represent a substituted or unsubstituted aryl group.

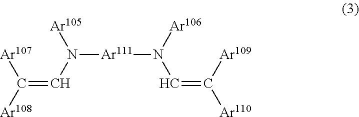

In the formula (3):

Ar¹⁰⁵ to Ar¹¹⁰ each independently represent a substituted or unsubstituted aryl group; and

Ar¹¹¹ represents a phenylene group or a 4,4′-biphenyldiyl group.

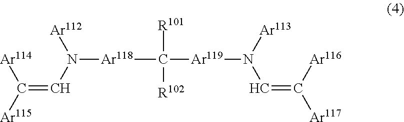

In the formula (4):

Ar¹¹² to Ar¹¹⁷ each independently represent a substituted or unsubstituted aryl group;

Ar¹¹⁸ and Ar¹¹⁹ each independently represent a phenylene group or a 4,4′-biphenyldiyl group; and

R¹⁰¹ and R¹⁰² each independently represent an alkyl group or a phenyl group, or R¹⁰¹ and R¹⁰² represent groups necessary for forming a ring structure by being bonded to each other together with a carbon atom to which R¹⁰¹ and R¹⁰² are bonded.

It is preferred that at least one of Ar¹⁰¹ to Ar¹⁰⁴, at least one of Ar¹⁰⁵ to Ar¹¹⁰, and at least one of Ar¹¹² to Ar¹¹⁷ in the formulae (2) to (4) each represent a 9,9-dimethyl-9H-fluoren-2-yl group.

Further, it is more preferred that Ar¹⁰⁵ and Ar¹⁰⁶ in the formula (3) each represent a 9,9-dimethyl-9H-fluoren-2-yl group.

In addition, it is more preferred that Ar¹¹² and Ar¹¹³ in the formula (4) each represent a 9,9-dimethyl-9H-fluoren-2-yl group and R¹⁰¹ and R¹⁰² in the formula (4) each represent a methyl group.

For example, a phenyl group, a naphthyl group, a fluorenyl group, a pyrenyl group, a biphenyl group, and a terphenyl group are given as an aryl group of the substituted or unsubstituted aryl group in the formulae (2) to (4). For example, the following substituents are given as a substituent of the substituted aryl group: alkyl groups, such as a methyl group, an ethyl group, and a propyl group; halogen-substituted alkyl groups, such as a trifluoromethyl group and a chloromethyl group; hydrocarbon group-substituted vinyl groups, such as a 4-fluoren-9-ylidene-methyl group, a 10,11-dihydro-dibenzo[a,d]cyclohepten-5-ylidene-methyl group, a 4-phenyl-buta-1,3-dienyl group, and a styryl group; alkoxy groups, such as a methoxy group and an ethoxy group; dialkylamino groups, such as a dimethylamino group and a diethylamino group; cyclic amino groups, such as a morpholino group and a piperidino group; and halogen atoms, such as a fluorine atom, a chlorine atom, and a bromine atom.

Examples of the ring structure in the formula (4), which may be formed of R¹⁰¹ and R¹⁰² bonded to each other together with a carbon atom to which R¹⁰¹ and R¹⁰² are bonded, include cycloalkanediyl groups, such as a cyclopentanediyl group, a cyclohexanediyl group, a cycloheptanediyl group, and a 4-methylcyclohexanediyl group.

Preferred specific examples (Exemplified Compounds) of the compounds represented by the formulae (2) to (4) contained in the electrophotographic photosensitive member of the present invention are shown below. However, the present invention is not limited thereto.

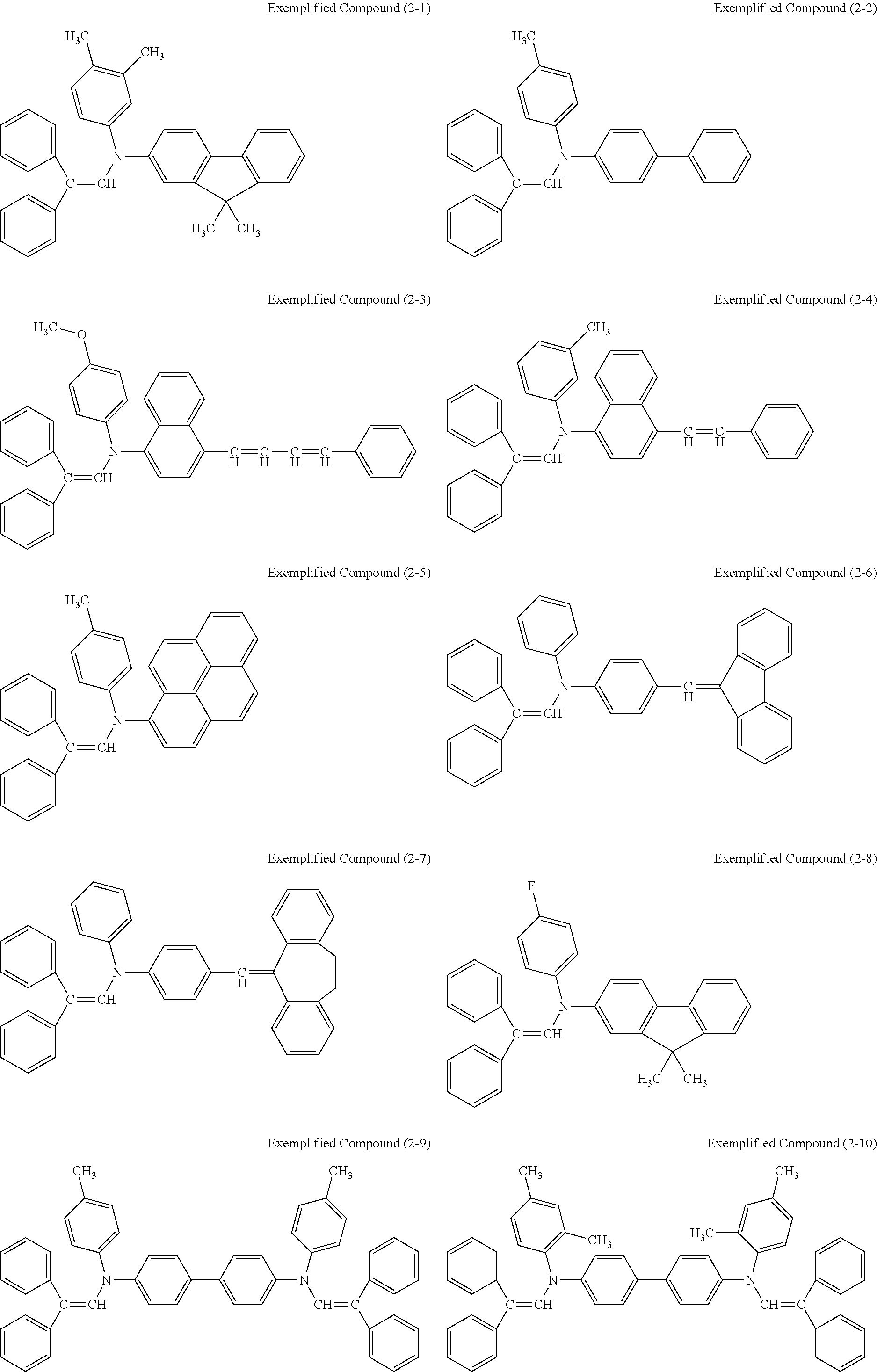

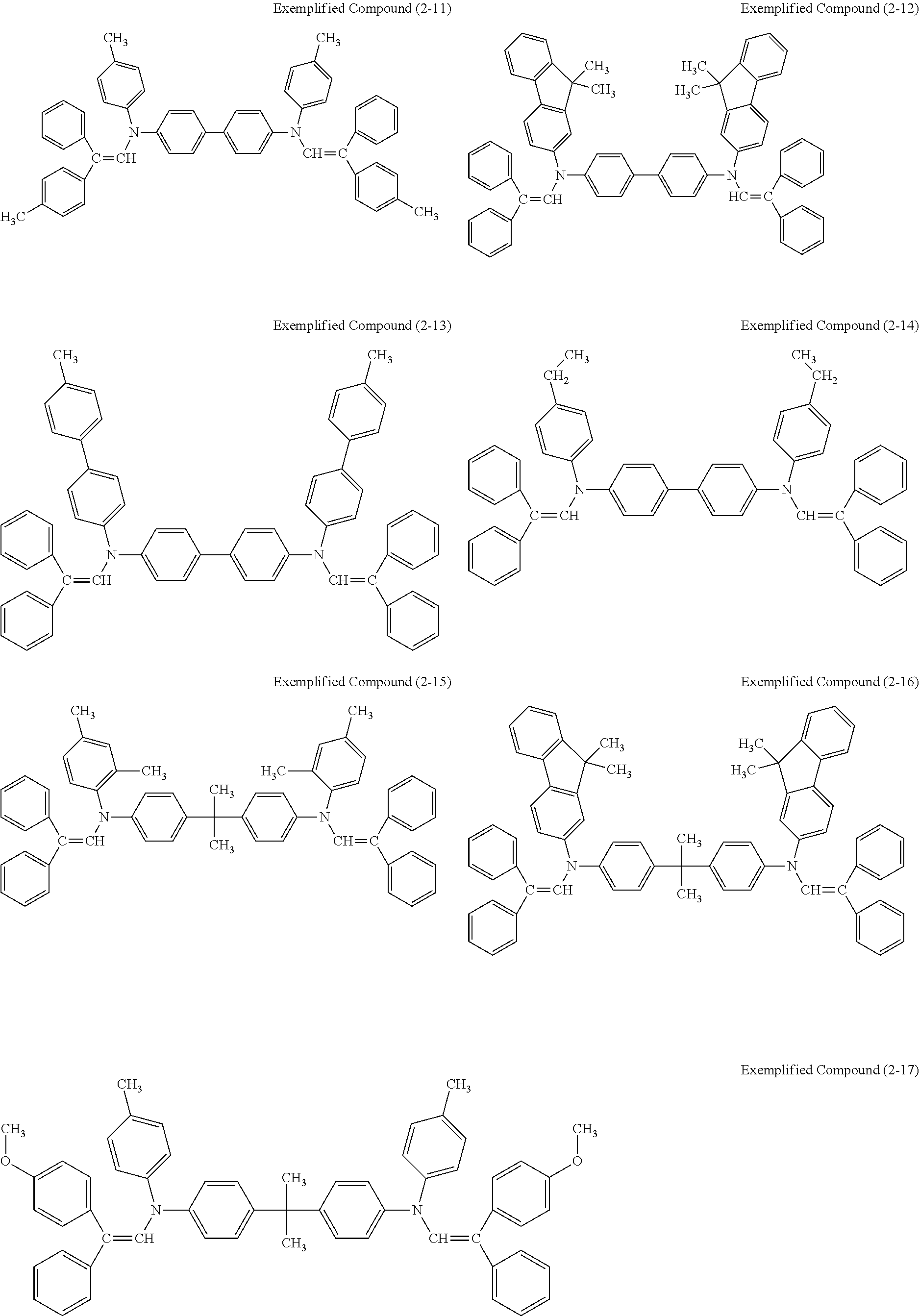

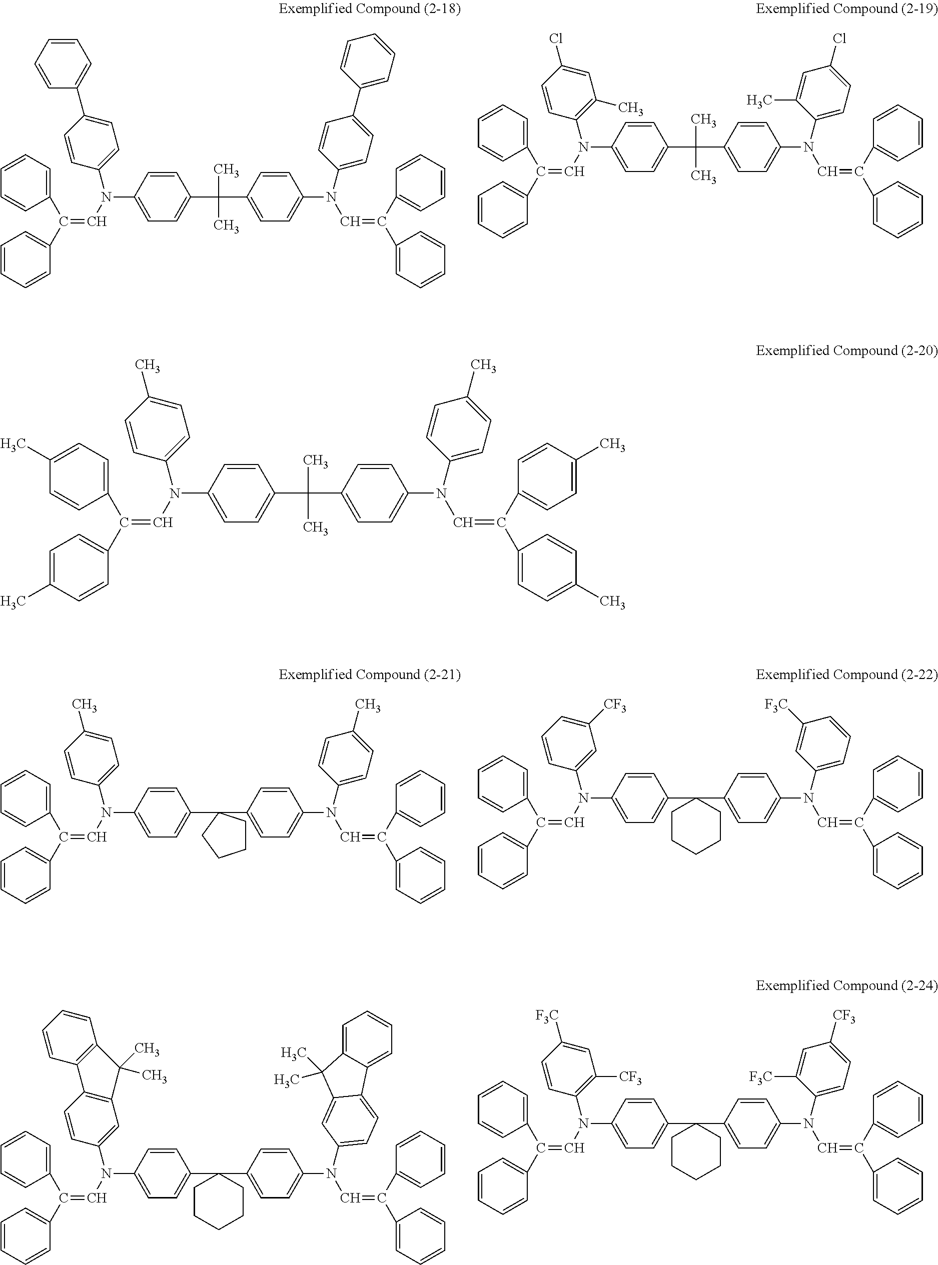

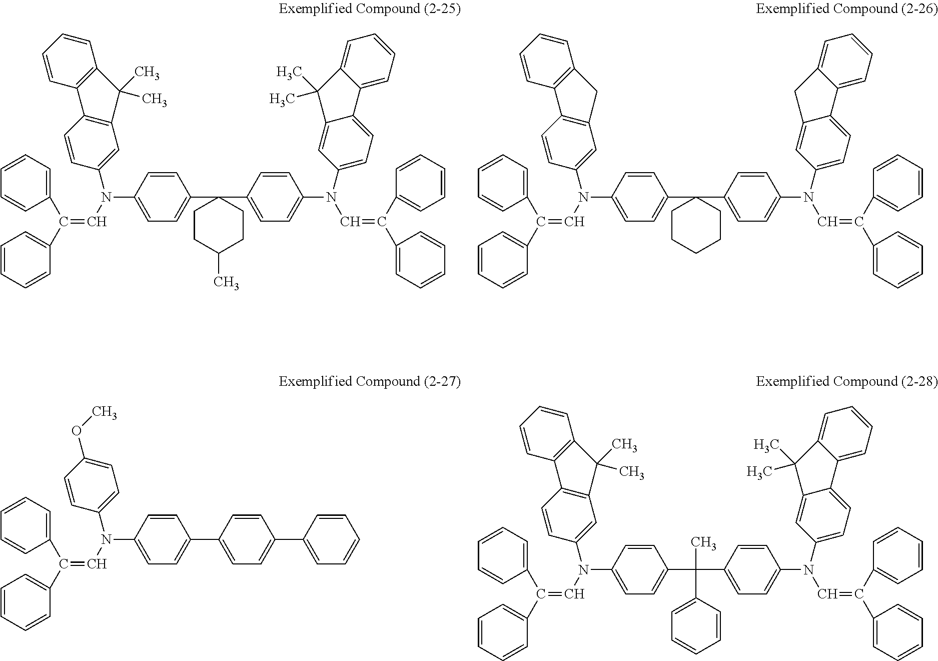

One kind of the compounds represented by the formulae (1) to (4) may be used alone, or two or more kinds thereof may be used in combination.

The content of the organic compound in the organic compound-containing gallium phthalocyanine crystal is more preferably 0.4% by mass or more and 1.4% by mass or less with respect to the mass of gallium phthalocyanine.

The organic compound is preferably N-methylformamide, N-propylformamide, or N-vinylformamide.

The gallium phthalocyanine crystal is a crystal of a phthalocyanine compound having gallium as a central metal. Of such gallium phthalocyanine crystals, hydroxygallium phthalocyanine crystals, chlorogallium phthalocyanine crystals, bromogallium phthalocyanine crystals, or iodogallium phthalocyanine crystals each having excellent sensitivity are preferred because the present invention effectively acts. Of those, hydroxygallium phthalocyanine crystals and chlorogallium phthalocyanine crystals are particularly preferred. In the hydroxygallium phthalocyanine crystal, a gallium atom has a hydroxy group as an axial ligand. In the chlorogallium phthalocyanine crystal, a gallium atom has a chlorine atom as an axial ligand. In the bromogallium phthalocyanine crystal, a gallium atom has a bromine atom as an axial ligand. In the iodogallium phthalocyanine crystal, a gallium atom has an iodine atom as an axial ligand.

Further, of the hydroxygallium phthalocyanine crystals, a hydroxygallium phthalocyanine crystal having peaks at Bragg angles 2θ± of 7.4°±0.3° and 28.3°±0.3° in CuKα X-ray diffraction is more preferred in terms of high sensitivity.

In addition, of the chlorogallium phthalocyanine crystals, a chlorogallium phthalocyanine crystal having peaks at Bragg angles 2θ±0.2° of 7.4°, 16.6°, 25.5°, and 28.3° in CuKα X-ray diffraction is more preferred in terms of high sensitivity.

A production method for the organic compound-containing gallium phthalocyanine crystal is described below.

The organic compound-containing gallium phthalocyanine crystal is obtained through a step including adding a gallium phthalocyanine raw material to a solvent containing an organic compound and subjecting the resultant to wet milling treatment, to perform crystal transformation of gallium phthalocyanine. The gallium phthalocyanine raw material to be used for the wet milling treatment is preferably gallium phthalocyanine obtained by an acid pasting method or dry milling treatment.

The wet milling treatment to be performed here is, for example, treatment to be performed with a milling apparatus, such as a sand mill or a ball mill, together with a dispersant as a medium for milling, such as glass beads, steel beads, or alumina balls. A milling time is preferably from about 30 hours to about 3,000 hours. A particularly preferred method is as described below. A sample is taken every 10 hours to 100 hours and the content of the organic compound in the gallium phthalocyanine crystal is confirmed by NMR measurement. The amount of the dispersant to be used in the wet milling treatment is preferably 10 times to 50 times as large as that of the gallium phthalocyanine on a mass basis.

The amount of the organic compound to be used is preferably 5 times to 30 times as large as that of the gallium phthalocyanine in the gallium phthalocyanine crystal on a mass basis.

In the present invention, whether or not the resultant organic compound-containing gallium phthalocyanine crystal contained therein the organic compound was determined by the NMR measurement of the gallium phthalocyanine crystal.

The X-ray diffraction measurement and NMR measurement of the organic compound-containing gallium phthalocyanine crystal contained in the electrophotographic photosensitive member of the present invention were performed under the following conditions.

(Powder X-Ray Diffraction Measurement)

Used measuring apparatus: X-ray diffractometer RINT-TTRII manufactured by Rigaku Corporation
X-ray tube bulb: Cu
Tube voltage: 50 kV
Tube current: 300 mA
Scanning method: 2θ/θ scan
Scanning rate: 4.0°/min
Sampling interval: 0.02°
Start angle (2θ): 5.0°
Stop angle (2θ): 40.0°
Attachment: standard sample holder
Filter: not used
Incident monochrome: used
Counter monochromator: not used
Divergence slit: open
Divergence longitudinal restriction slit: 10.00 mm
Scattering slit: open
Light-receiving slit: open
Flat monochromator: used
Counter: scintillation counter

### (NMR Measurement)

Used measuring apparatus: AVANCE III 500 manufactured by BRUKER
Solvent: deuterated sulfuric acid (D₂SO₄)

In the electrophotographic photosensitive member of the present invention, the charge-generating layer and the charge-transporting layer are laminated so that the charge-generating layer is a lower layer.

The support to be used in the present invention is preferably a support having conductivity (conductive support). Examples thereof include a metal or an alloy, such as aluminum or stainless steel, and a metal, alloy, plastic, and paper provided with a conductive layer. Examples of a shape of the support include a cylinder and a film.

In the present invention, an undercoat layer having a barrier function and an adhesion function (sometimes referred to as “intermediate layer”) may be formed between the support and the charge-generating layer.

As the material for the undercoat layer, there may be used polyvinyl alcohol, polyethylene oxide, ethyl cellulose, methyl cellulose, casein, polyamide, glue, gelatin, and the like. The undercoat layer may be formed by: applying a coating liquid for an undercoat layer containing the above-mentioned materials onto the support to form a coating; and drying the resultant coating. In addition, a metal oxide may be added as a resistance controlling agent.

The thickness of the undercoat layer is preferably from 0.3 μm to 5.0 μm.

Further, a conductive layer is preferably formed between the support and the undercoat layer to cover irregularities or deficiencies in the support or to prevent formation of interference fringes.

The conductive layer may be formed by dispersing conductive particles, such as carbon black, metal particles, and a metal oxide, in a binder resin.

The thickness of the conductive layer is preferably from 5 μm to 40 μm, particularly preferably from 10 μm to 30 μm.

The charge-generating layer can be formed by: forming a coating of a coating liquid for a charge-generating layer, which contains a gallium phthalocyanine crystal in which an organic compound is contained and a binder resin; and drying the coating. The coating liquid for a charge-generating layer can be prepared by dispersing an organic compound-containing gallium phthalocyanine crystal in a solvent together with a binder resin.

The thickness of the charge-generating layer is preferably from 0.05 μm to 1 μm, more preferably from 0.1 μm to 0.3 μm.

The content of the organic compound-containing gallium phthalocyanine crystal in the charge-generating layer is preferably 40% by mass or more and 85% by mass or less, more preferably 60% by mass or more and 80% by mass or less with respect to the total mass of the charge-generating layer.

Examples of the binder resin to be used for the charge-generating layer include resins such as polyester, an acrylic resin, polycarbonate, polyvinyl butyral, polystyrene, polyvinyl acetate, polysulfone, an acrylonitrile copolymer, and polyvinyl benzal. Of those, polyvinyl butyral and polyvinyl benzal are preferred from the viewpoint of dispersibility of the organic compound-containing gallium phthalocyanine crystal. One kind of the resins may be used alone, or two or more kinds thereof may be used in combination.

The charge-transporting layer is a layer including a charge-transporting substance and can be formed by forming a coating of a coating liquid for a charge-transporting layer, which contains at least one compound selected from compounds represented by the formulae (1) to (4) and a binder resin, and drying the resultant coating. In addition, to the charge-transporting layer, there may be added at least one kind of additive selected from, for example, a mold release agent for enhancing transcription efficiency of a toner, an anti-fingerprint agent for preventing stains or the like, a filler for suppressing scratches, and a lubricant for enhancing a lubricating property on the drum surface.

The thickness of the charge-transporting layer is preferably from 5 μm to 40 μm, particularly preferably from 10 μm to 25 μm.

The content of at least one of compound selected from the compounds represented by the formulae (1) to (4) in the charge-transporting layer is preferably 10% by mass or more and 60% by mass or less, more preferably 20% by mass or more and 50% by mass or less with respect to the total mass of the charge-transporting layer. It should be noted that, when the charge-transporting layer contains two or more kinds of compounds, the content of at least one of compound selected from the compounds represented by the formulae (1) to (4) in the charge-transporting layer is a content determined based on the total amount of the compounds. In addition, a charge-transporting substance except the compounds represented by the formulae (1) to (4) may be added, and the content of the charge-transporting substance except the compounds represented by the formulae (1) to (4) in the charge-transporting layer is preferably from 20% by mass to 80% by mass, particularly preferably from 30% by mass to 60% by mass with respect to the total mass of the charge-transporting layer.

Examples of the charge-transporting substance to be added include a triarylamine compound, a hydrazone compound, a stilbene compound, a pyrazoline compound, an oxazole compound, a thiazole compound, and a triallylmethane compound. One kind of those charge-transporting substances may be added and used alone, or two or more kinds thereof may be added and used in combination.

Examples of the binder resin to be used in the charge-transporting layer include resins, such as polyester, an acrylic resin, a phenoxy resin, polycarbonate, polysulfone, polyarylate, and an acrylonitrile copolymer. Of those, polycarbonate and polyarylate are preferred. One kind of the resins may be used alone, or two or more kinds thereof may be used in combination.

An application method selected from, for example, an immersion coating method (dipping method), a spray coating method, a spinner coating method, a bead coating method, a blade coating method, and a beam coating method can be used as a method of applying each layer.

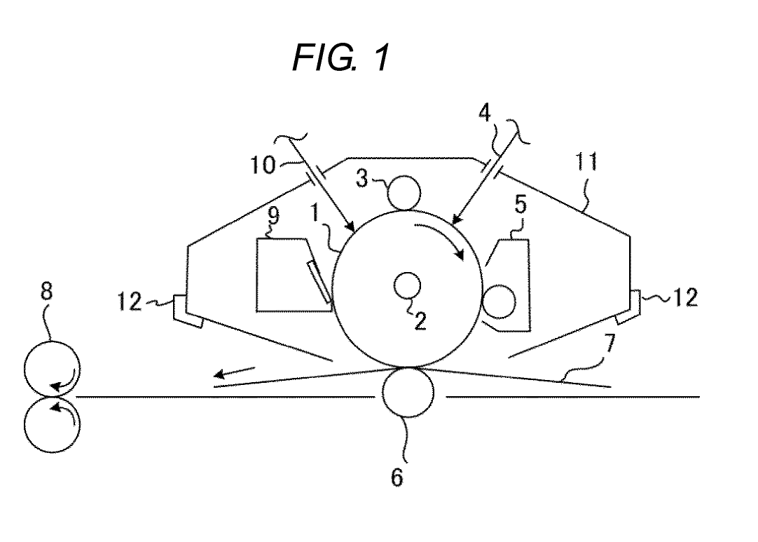

FIG. 1 is a view for illustrating an example of the schematic configuration of an electrophotographic apparatus including a process cartridge including the electrophotographic photosensitive member of the present invention. The electrophotographic apparatus includes an electrophotographic photosensitive member 1 having a cylindrical shape (drum shape). The electrophotographic photosensitive member 1 is rotationally driven about an axis 2 in a direction indicated by the arrow at a predetermined peripheral speed (process speed). The surface of the electrophotographic photosensitive member 1 is charged to a predetermined positive or negative electric potential by a charging device 3 during the rotation process. Next, the charged surface of the electrophotographic photosensitive member 1 is irradiated with image exposure light 4 from an image exposing device (not shown) and then an electrostatic latent image corresponding to target image information is formed. The image exposure light 4 is, for example, light to be output from the image exposing device, such as a slit exposure or a laser beam scanning exposure, the light having intensity modulated in correspondence with a time-series electrical digital image signal of the target image information.

The electrostatic latent image formed on the surface of the electrophotographic photosensitive member 1 is developed (subjected to normal development or reversal development) with toner stored in a developing device 5. Thus, a toner image is formed on the surface of the electrophotographic photosensitive member 1. The toner image formed on the surface of the electrophotographic photosensitive member 1 is transferred onto a transfer material 7 by a transferring device 6. At this time, a bias voltage opposite in polarity to the charge which the toner possesses is applied from a bias power source (not shown) to the transferring device 6. In addition, when the transfer material 7 is paper, the transfer material 7 is taken out of a sheet-feeding portion (not shown), and is then fed into a gap between the electrophotographic photosensitive member 1 and the transferring device 6 in synchronization with the rotation of the electrophotographic photosensitive member 1.

The transfer material 7 onto which the toner image has been transferred from the electrophotographic photosensitive member 1 is separated from the surface of the electrophotographic photosensitive member 1 and then conveyed to an image fixing device 8 where the transfer material is subjected to treatment for fixing the toner image. Thus, the transfer material is printed out as an image-formed product (print or copy) to the outside of the electrophotographic apparatus.

The surface of the electrophotographic photosensitive member 1 after the transfer of the toner image onto the transfer material 7 is subjected to the removal of a deposit, such as the toner (transfer residual toner), by a cleaning device 9, thereby being cleaned. A cleaner-less system has been developed in recent years and hence the transfer residual toner can be directly removed with developing equipment or the like. Further, the surface of the electrophotographic photosensitive member 1 is subjected to antistatic treatment by pre-exposure light from a pre-exposing device (not shown) before being repeatedly used for image formation. It should be noted that when the charging device 3 is a contact charging device using a charging roller or the like, the pre-exposing device is not necessarily needed.

In the present invention, the following procedure may be adopted. A plurality of components out of the components, such as the electrophotographic photosensitive member 1, the charging device 3, the developing device 5, transferring device 6 and the cleaning device 9, can be stored in a container and integrally supported to form a process cartridge. In addition, the process cartridge can be detachably mountable to the main body of the electrophotographic apparatus. For example, the following procedure can be adopted. At least one selected from the charging device 3, the developing device 5, transferring device 6 and the cleaning device 9 is integrally supported with the electrophotographic photosensitive member 1 to form a cartridge. Then, the cartridge is used as a process cartridge 11 detachably mountable to the main body of the electrophotographic apparatus with a guiding device 12, such as a rail of the main body of the electrophotographic apparatus.

When the electrophotographic apparatus is a copying machine or a printer, the image exposure light 4 may be reflected light or transmitted light from an original. Alternatively, the light may be light radiated by, for example, scanning with a laser beam, the driving of a LED array, or the driving of a liquid crystal shutter array to be performed according to a signal turned from the original read with a sensor.

The electrophotographic photosensitive member 1 of the present invention is also widely applicable to the fields of application of electrophotography, such as a laser beam printer, a CRT printer, a LED printer, a FAX, a liquid crystal printer, and laser plate making.

Now, the present invention is described in more detail by way of specific Examples. However, the present invention is not limited to these Examples. The term “part(s)” in the following description means “part(s) by mass.” It should be noted that the thickness of each layer of any one of the electrophotographic photosensitive members of Examples and Comparative Examples was determined with an eddy-current thickness meter (Fischerscope manufactured by Fischer Instruments), or was determined from its mass per unit area by specific gravity conversion.

### Synthesis Example 1

In a nitrogen flow atmosphere, 5.46 parts of phthalonitrile and 45 parts of α-chloronaphthalene were added to a reaction furnace and heated up to a temperature of 30° C., and the temperature was maintained. Next, 3.75 parts of gallium trichloride was added thereto at the temperature (30° C.). The moisture value of the mixture at the time of addition was 150 ppm. After that, the mixture was heated to a temperature of 200° C. Next, in a nitrogen flow atmosphere, the mixture was allowed to react at a temperature of 200° C. for 4.5 hours and cooled, and the resultant product was filtered when the temperature reached 150° C. The filter residue was dispersed in and washed with N,N-dimethylformamide at a temperature of 140° C. for 2 hours, followed by filtration. The resultant filter residue was washed with methanol and dried to yield 4.65 parts (yield 71%) of a chlorogallium phthalocyanine pigment.

### Synthesis Example 2

4.65 Parts of the chlorogallium phthalocyanine pigment obtained in Synthesis Example 1 was dissolved in 139.5 parts of concentrated sulfuric acid at a temperature of 10° C., and the solution was added dropwise with stirring to 620 parts of ice water to reprecipitate the pigment, followed by filtration using a filter press. The resultant wet cake (filter residue) was dispersed in and washed with 2% ammonia water, followed by filtration using a filter press. Next, the resultant wet cake (filter residue) was dispersed in and washed with ion exchange water, and then filtration using the filter press was repeated three times to yield a hydroxygallium phthalocyanine pigment having a solid content of 23% (aqueous hydroxygallium phthalocyanine pigment) (acid pasting treatment).

Next, 6.6 kg of the resultant hydroxygallium phthalocyanine pigment (aqueous hydroxygallium phthalocyanine pigment) was dried as described below using a hyper-dry dryer ((trade name: HD-06R, frequency (oscillation frequency): 2,455 MHz±15 MHz, manufactured by Biocon Ltd.).

The resultant hydroxygallium phthalocyanine pigment in a solid state (thickness of the water-containing cake: 4 cm or less) taken out from the filter press was placed on a dedicated circular plastic tray, and the apparatus was set so that far infrared rays were turned off and the temperature of the inner wall of the dryer was 50° C. Then, a vacuum pump and a leak valve were adjusted during microwave irradiation to adjust a vacuum degree to from 4.0 kPa to 10.0 kPa.

First, in the first step, the hydroxygallium phthalocyanine pigment was irradiated with 4.8 kW of a microwave for 50 minutes. Next, the microwave was turned off once, and the leak valve was closed once to form a high-vacuum state of 2 kPa or less. At this point, the solid content of the hydroxygallium phthalocyanine pigment was 88%.

In the second step, the leak valve was adjusted to adjust the vacuum degree (pressure in the dryer) within the values defined above (from 4.0 kPa to 10.0 kPa), and the hydroxygallium phthalocyanine pigment was irradiated with 1.2 kW of a microwave for 5 minutes. Then, the microwave was turned off once, and the leak valve was closed once to form a high-vacuum state of 2 kPa or less. The second step was further repeated once (twice in total). At this point, the solid content of the hydroxygallium phthalocyanine pigment was 98%.

Further, in the third step, microwave irradiation was carried out in the same manner as in the second step except that the power of the microwave in the second step was changed from 1.2 kW to 0.8 kW. The third step was further repeated once (twice in total).

Further, in the fourth step, the leak valve was adjusted to recover the vacuum degree (pressure in the dryer) to within the values defined above (from 4.0 kPa to 10.0 kPa), and the hydroxygallium phthalocyanine pigment was irradiated with 0.4 kW of a microwave for 3 minutes. Then, the microwave was turned off once, and the leak valve was closed once to form a high-vacuum state of 2 kPa or less. The fourth step was further repeated seven times (eight times in total).

Thus, 1.52 kg of a hydroxygallium phthalocyanine pigment having a water content of 1% or less was obtained in 3 hours in total.

### Preparation Example 1

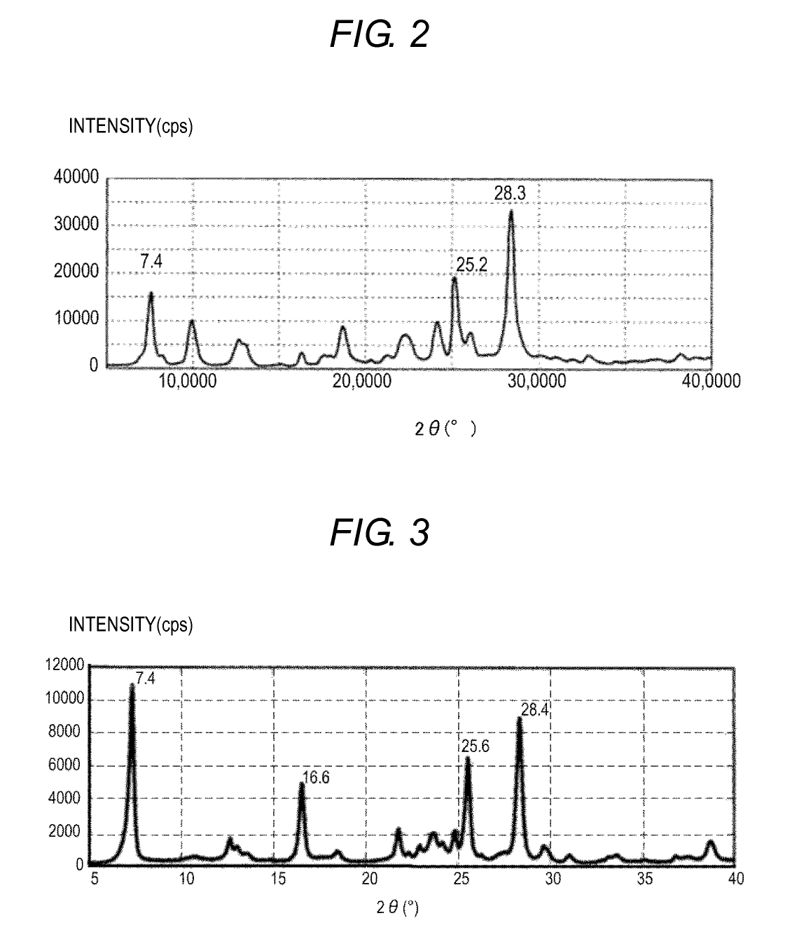

0.5 Part of the hydroxygallium phthalocyanine pigment obtained in Synthesis Example 2 and 10 parts of N,N-dimethylformamide were subjected to wet milling treatment with a ball mill together with 20 parts of glass beads each having a diameter of 0.8 mm at room temperature (23° C.) for 400 hours. This step was carried out using a standard bottle (product code: PS-6, manufactured by Hakuyo Glass Co., Ltd.) as a container under a condition in which the container was rotated 120 times per minute. An organic compound-containing gallium phthalocyanine crystal was taken out from the dispersion thus obtained with N,N-dimethylformamide and filtered, and then the residue on the filter was sufficiently washed with tetrahydrofuran. The filter residue was vacuum-dried to yield 0.45 part of an organic compound-containing hydroxygallium phthalocyanine crystal. The powder X-ray diffraction spectrum of the resultant crystal is shown in FIG. 2.

In addition, NMR measurement confirmed that the hydroxygallium phthalocyanine crystal obtained in this preparation example contained 1.4% by mass of N,N-dimethylformamide with respect to the mass of hydroxygallium phthalocyanine in the crystal, the content being converted from the ratio of protons. The crystal is found to contain N,N-dimethylformamide because N,N-dimethylformamide is compatible with tetrahydrofuran.

### Preparation Example 2

0.43 Part of an organic compound-containing hydroxygallium phthalocyanine crystal was obtained by the same treatment as that of Preparation Example 1 except that in Preparation Example 1, the time for the milling treatment was changed from 400 hours to 2,000 hours. The powder X-ray diffraction spectrum of the resultant organic compound-containing hydroxygallium phthalocyanine crystal was similar to that of FIG. 2.

In addition, NMR measurement confirmed that the hydroxygallium phthalocyanine crystal obtained in this preparation example contained 0.8% by mass of N,N-dimethylformamide with respect to the mass of hydroxygallium phthalocyanine in the crystal, the content being converted from the ratio of protons.

### Preparation Example 3

0.39 Part of an organic compound-containing hydroxygallium phthalocyanine crystal was obtained by the same treatment as that of Preparation Example 1 except that in Preparation Example 1, 10 parts of N,N-dimethylformamide was changed to 10 parts of dimethyl sulfoxide and the time for the wet milling treatment was changed from 400 hours to 2,000 hours. The powder X-ray diffraction spectrum of the resultant organic compound-containing hydroxygallium phthalocyanine crystal was similar to that of FIG. 2.

In addition, NMR measurement confirmed that the hydroxygallium phthalocyanine crystal obtained in this preparation example contained 0.7% by mass of dimethyl sulfoxide with respect to the mass of hydroxygallium phthalocyanine in the crystal, the content being converted from the ratio of protons.

### Preparation Example 4

0.45 Part of an organic compound-containing hydroxygallium phthalocyanine crystal was obtained by the same treatment as that of Preparation Example 1 except that in Preparation Example 1, 10 parts of N,N-dimethylformamide was changed to 10 parts of N-methylformamide and the time for the wet milling treatment was changed from 400 hours to 200 hours. The powder X-ray diffraction spectrum of the resultant organic compound-containing hydroxygallium phthalocyanine crystal was similar to that of FIG. 2.

In addition, NMR measurement confirmed that the hydroxygallium phthalocyanine crystal obtained in this preparation example contained 1.2% by mass of N-methylformamide with respect to the mass of hydroxygallium phthalocyanine in the crystal, the content being converted from the ratio of protons.

### Preparation Example 5

0.43 Part of an organic compound-containing hydroxygallium phthalocyanine crystal was obtained by the same treatment as that of Preparation Example 4 except that in Preparation Example 4, the time for the wet milling treatment was changed from 200 hours to 1,000 hours. The powder X-ray diffraction spectrum of the resultant organic compound-containing hydroxygallium phthalocyanine crystal was similar to that of FIG. 2.

In addition, NMR measurement confirmed that the hydroxygallium phthalocyanine crystal obtained in this preparation example contained 0.5% by mass of N-methylformamide with respect to the mass of hydroxygallium phthalocyanine in the crystal, the content being converted from the ratio of protons.

### Preparation Example 6

0.43 Part of an organic compound-containing hydroxygallium phthalocyanine crystal was obtained by the same treatment as that of Preparation Example 1 except that in Preparation Example 1, 10 parts of N,N-dimethylformamide was changed to 10 parts of N-n-propylformamide and the time for the wet milling treatment was changed from 400 hours to 1,000 hours. The powder X-ray diffraction spectrum of the resultant organic compound-containing hydroxygallium phthalocyanine crystal was similar to that of FIG. 2.

In addition, NMR measurement confirmed that the hydroxygallium phthalocyanine crystal obtained in this preparation example contained 0.9% by mass of N-n-propylformamide with respect to the mass of hydroxygallium phthalocyanine in the crystal, the content being converted from the ratio of protons.

### Preparation Example 7

0.45 Part of an organic compound-containing hydroxygallium phthalocyanine crystal was obtained by the same treatment as that of Preparation Example 1 except that in Preparation Example 1, 10 parts of N,N-dimethylformamide was changed to 10 parts of N-vinylformamide and the time for the wet milling treatment was changed from 400 hours to 600 hours. The powder X-ray diffraction spectrum of the resultant organic compound-containing hydroxygallium phthalocyanine crystal was similar to that of FIG. 2.

In addition, NMR measurement confirmed that the hydroxygallium phthalocyanine crystal obtained in this preparation example contained 1.5% by mass of N-vinylformamide with respect to the mass of hydroxygallium phthalocyanine in the crystal, the content being converted from the ratio of protons.

### Preparation Example 8

0.44 Part of an organic compound-containing hydroxygallium phthalocyanine crystal was obtained by the same treatment as that of Preparation Example 1 except that in Preparation Example 1, 10 parts of N,N-dimethylformamide was changed to 10 parts of N-methyl-2-pyrrolidone and the time for the wet milling treatment was changed from 400 hours to 800 hours. The powder X-ray diffraction spectrum of the resultant organic compound-containing hydroxygallium phthalocyanine crystal was similar to that of FIG. 2.

In addition, NMR measurement confirmed that the hydroxygallium phthalocyanine crystal obtained in this preparation example contained 1.4% by mass of N-methyl-2-pyrrolidone with respect to the mass of hydroxygallium phthalocyanine in the crystal, the content being converted from the ratio of protons.

### Preparation Example 9

0.5 Part of the chlorogallium phthalocyanine pigment obtained in Synthesis Example 1 was subjected to dry milling treatment with a ball mill together with 20 parts of glass beads each having a diameter of 0.8 mm at room temperature (23° C.) for 40 hours. 10 Parts of N,N-dimethylformamide was added thereto, and the resultant was subjected to wet milling treatment at room temperature (23° C.) for 100 hours.

A chlorogallium phthalocyanine crystal was taken out from the resultant dispersion with N,N-dimethylformamide and filtered, and then the residue on the filter was sufficiently washed with tetrahydrofuran. The filter residue was vacuum-dried to yield 0.44 part of an organic compound-containing chlorogallium phthalocyanine crystal. The powder X-ray diffraction spectrum of the resultant crystal is shown in FIG. 3.

In addition, NMR measurement confirmed that the chlorogallium phthalocyanine crystal obtained in this preparation example contained 1.0% by mass of N,N-dimethylformamide with respect to the mass of chlorogallium phthalocyanine in the crystal, the content being converted from the ratio of protons.

### Preparation Example 10

0.45 Part of a chlorogallium phthalocyanine crystal was obtained by the same treatment as that of Preparation Example 9 except that in Preparation Example 9, 10 parts of N,N-dimethylformamide was changed to 10 parts of N-methylformamide. The powder X-ray diffraction spectrum of the resultant chlorogallium phthalocyanine crystal was similar to that of FIG. 3.

In addition, NMR measurement confirmed that the chlorogallium phthalocyanine crystal obtained in this preparation example contained 1.5% by mass of N-methylformamide with respect to the mass of chlorogallium phthalocyanine in the crystal, the content being converted from the ratio of protons.

### Comparative Preparation Example 1

0.46 Part of an organic compound-containing hydroxygallium phthalocyanine crystal was obtained by the same treatment as that of Preparation Example 1 except that in Preparation Example 1, the time for the wet milling treatment was changed from 400 hours to 48 hours.

In addition, NMR measurement confirmed that the hydroxygallium phthalocyanine crystal obtained in this comparative preparation example contained 2.1% by mass of N,N-dimethylformamide with respect to the mass of hydroxygallium phthalocyanine in the crystal, the content being converted from the ratio of protons.

### Comparative Preparation Example 2

0.41 Part of an organic compound-containing hydroxygallium phthalocyanine crystal was obtained by the same treatment as that of Preparation Example 3 except that in Preparation Example 3, the time for the milling treatment was changed from 2,000 hours to 48 hours.

In addition, NMR measurement confirmed that the hydroxygallium phthalocyanine crystal obtained in this comparative preparation example contained 2.1% by mass of dimethyl sulfoxide with respect to the mass of hydroxygallium phthalocyanine in the crystal, the content being converted from the ratio of protons.

### Example 1-1

A solution containing the following components was subjected to dispersion treatment with a ball mill for 20 hours to prepare a coating liquid for a conductive layer.

| | | |
|---|---|---|
| Barium sulfate particles coated with tin oxide (trade | 60 | parts |
| name: Passtran PC1, manufactured by Mitsui Mining & | | |
| Smelting Co., Ltd.) | | |
| Titanium oxide particles (trade name: TITANIX JR, | 15 | parts |
| manufactured by Tayca Corporation) | | |
| Resole-type phenol resin (trade name: PHENOLITE J-325, | 43 | parts |
| manufactured by DIC Corporation, solid content: 70% by | | |
| mass) | | |
| Silicone oil (trade name: SH 28 PA, manufactured by Dow | 0.015 | parts |
| Corning Toray Co., Ltd.) | | |
| Silicone resin (trade name: Tospearl 120, manufactured by | 3.6 | parts |
| Momentive Performance Materials Inc.) | | |
| 2-Methoxy-1-propanol | 50 | parts |
| Methanol | 50 | parts |

The coating liquid for a conductive layer was applied onto the outer peripheral surface of an aluminum cylinder as a support by immersion and then the resultant coating was dried for 30 minutes at 140° C. Thus, a conductive layer having a thickness of 15 μm was formed.

Next, 10 parts of a copolymer nylon resin (trade name: Amilan CM8000, manufactured by Toray Industries, Inc.) and 30 parts of a methoxymethylated 6-nylon resin (trade name: Toresin EF-30T, manufactured by Nagase ChemteX Corporation) were dissolved in a mixed solvent of 400 parts of methanol and 200 parts of n-butanol. Thus, a coating liquid for an undercoat layer was prepared.

The coating liquid for an undercoat layer was applied onto the conductive layer by immersion and then the resultant coating was dried. Thus, an undercoat layer having a thickness of 0.5 μm was formed.

Next, 10 parts of the organic compound-containing hydroxygallium phthalocyanine crystal (charge-generating substance) obtained in Preparation Example 1, 5 parts of polyvinyl butyral (trade name: S-LEC BX-1, manufactured by Sekisui Chemical Co., Ltd.), and 250 parts of cyclohexanone were loaded into a sand mill using glass beads each having a diameter of 1 mm, and were then subjected to dispersion treatment for 6 hours. The treated product was diluted with 250 parts of ethyl acetate. Thus, a coating liquid for a charge-generating layer was prepared.

The coating liquid for a charge-generating layer was applied onto the undercoat layer by immersion and then the resultant coating was dried for 10 minutes at 100° C. Thus, a charge-generating layer having a thickness of 0.18 μm was formed.

Next, the following components were dissolved in a mixed solvent of 70 parts of o-xylene and 20 parts of dimethoxymethane. Thus, a coating liquid for a charge-transporting layer was prepared.

| | |
|---|---|
| Compound represented as Exemplified Compound (1-12) (charge-transporting substance) | 8 parts |
| Lubricant represented by the following formula (PcSi-1) | 0.1 part |
| Polycarbonate (trade name: Iupilon Z-200, manufactured by Mitsubishi Gas Chemical Company, Inc.) | 10 parts |

(PcSi-1)

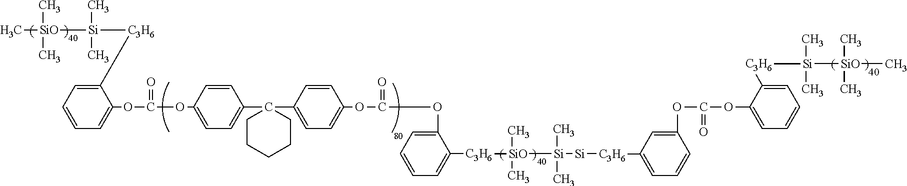

The coating liquid for a charge-transporting layer was applied onto the charge-generating layer by immersion and the resultant coating was dried for 1 hour at 125° C. Thus, a charge-transporting layer having a thickness of 22 μm was formed.

Thus, an electrophotographic photosensitive member of this example having a cylindrical shape (drum shape) was produced.

### Example 1-2

An electrophotographic photosensitive member of this example was produced in the same manner as in Example 1-1 except that in Example 1-1, the organic compound-containing hydroxygallium phthalocyanine crystal obtained in Preparation Example 1 used in the preparation of the coating liquid for a charge-generating layer was changed to the organic compound-containing hydroxygallium phthalocyanine crystal obtained in Preparation Example 2, and Exemplified Compound (1-12) used in the preparation of the coating liquid for a charge-transporting layer was changed to Exemplified Compound (1-1).

### Example 1-3

An electrophotographic photosensitive member of this example was produced in the same manner as in Example 1-1 except that in Example 1-1, the organic compound-containing hydroxygallium phthalocyanine crystal obtained in Preparation Example 1 used in the preparation of the coating liquid for a charge-generating layer was changed to the organic compound-containing hydroxygallium phthalocyanine crystal obtained in Preparation Example 3, and Exemplified Compound (1-12) used in the preparation of the coating liquid for a charge-transporting layer was changed to Exemplified Compound (1-21).

### Example 1-4

An electrophotographic photosensitive member of this example was produced in the same manner as in Example 1-1 except that in Example 1-1, the organic compound-containing hydroxygallium phthalocyanine crystal obtained in Preparation Example 1 used in the preparation of the coating liquid for a charge-generating layer was changed to the organic compound-containing hydroxygallium phthalocyanine crystal obtained in Preparation Example 4, and Exemplified Compound (1-12) used in the preparation of the coating liquid for a charge-transporting layer was changed to Exemplified Compound (1-1).

### Example 1-5

An electrophotographic photosensitive member of this example was produced in the same manner as in Example 1-4 except that in Example 1-4, 8 parts of Exemplified Compound (1-1) used in the preparation of the coating liquid for a charge-transporting layer was changed to 6 parts of Exemplified Compound (1-5) and 3 parts of a compound (charge-transporting substance) represented by the following formula (CTM-1).

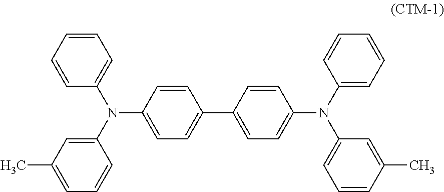

### Example 1-6

An electrophotographic photosensitive member of this example was produced in the same manner as in Example 1-4 except that in Example 1-4, 8 parts of Exemplified Compound (1-1) used in the preparation of the coating liquid for a charge-transporting layer was changed to 5 parts of Exemplified Compound (1-10) and 3 parts of a compound (charge-transporting substance) represented by the following formula (CTM-2).

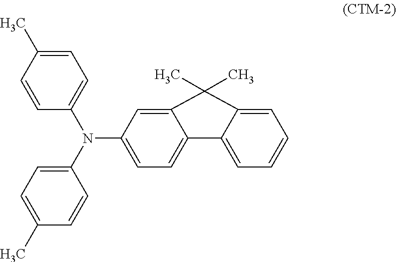 [SMILES: Cc1ccc(N(c2ccc(C)cc2)c2ccc3c(c2)C(C)(C)c2ccccc2-3)cc1]

### Example 1-7

An electrophotographic photosensitive member of this example was produced in the same manner as in Example 1-1 except that in Example 1-1, the organic compound-containing hydroxygallium phthalocyanine crystal obtained in Preparation Example 1 used in the preparation of the coating liquid for a charge-generating layer was changed to the organic compound-containing hydroxygallium phthalocyanine crystal obtained in Preparation Example 5, and Exemplified Compound (1-12) used in the preparation of the coating liquid for a charge-transporting layer was changed to Exemplified Compound (1-2).

### Example 1-8

An electrophotographic photosensitive member of this example was produced in the same manner as in Example 1-1 except that in Example 1-1, the organic compound-containing hydroxygallium phthalocyanine crystal obtained in Preparation Example 1 used in the preparation of the coating liquid for a charge-generating layer was changed to the organic compound-containing hydroxygallium phthalocyanine crystal obtained in Preparation Example 6, and Exemplified Compound (1-12) used in the preparation of the coating liquid for a charge-transporting layer was changed to Exemplified Compound (1-13).

### Example 1-9

An electrophotographic photosensitive member of this example was produced in the same manner as in Example 1-1 except that in Example 1-1, the organic compound-containing hydroxygallium phthalocyanine crystal obtained in Preparation Example 1 used in the preparation of the coating liquid for a charge-generating layer was changed to the organic compound-containing hydroxygallium phthalocyanine crystal obtained in Preparation Example 7, and Exemplified Compound (1-12) used in the preparation of the coating liquid for a charge-transporting layer was changed to Exemplified Compound (1-15).

### Example 1-10

An electrophotographic photosensitive member of this example was produced in the same manner as in Example 1-1 except that in Example 1-1, the organic compound-containing hydroxygallium phthalocyanine crystal obtained in Preparation Example 1 used in the preparation of the coating liquid for a charge-generating layer was changed to the organic compound-containing hydroxygallium phthalocyanine crystal obtained in Preparation Example 8, and Exemplified Compound (1-12) used in the preparation of the coating liquid for a charge-transporting layer was changed to Exemplified Compound (1-28).

### Example 1-11

An electrophotographic photosensitive member of this example was produced in the same manner as in Example 1-1 except that in Example 1-1, the organic compound-containing hydroxygallium phthalocyanine crystal obtained in Preparation Example 1 used in the preparation of the coating liquid for a charge-generating layer was changed to the organic compound-containing chlorogallium phthalocyanine crystal obtained in Preparation Example 9.

### Example 1-12

An electrophotographic photosensitive member of this example was produced in the same manner as in Example 1-1 except that in Example 1-1, the organic compound-containing hydroxygallium phthalocyanine crystal obtained in Preparation Example 1 used in the preparation of the coating liquid for a charge-generating layer was changed to the organic compound-containing chlorogallium phthalocyanine crystal obtained in Preparation Example 10, and Exemplified Compound (1-12) used in the preparation of the coating liquid for a charge-transporting layer was changed to Exemplified Compound (1-23).

### Comparative Example 1-1

An electrophotographic photosensitive member of the comparative example was produced in the same manner as in Example 1-1 except that in Example 1-1, the organic compound-containing hydroxygallium phthalocyanine crystal obtained in Preparation Example 1 used in the preparation of the coating liquid for a charge-generating layer was changed to the organic compound-containing hydroxygallium phthalocyanine crystal obtained in Comparative Preparation Example 1, and 8 parts of Exemplified Compound (1-12) used in the preparation of the coating liquid for a charge-transporting layer was changed to 4 parts of the compound (charge-transporting substance) represented by the formula (CTM-1) and 4 parts of the compound (charge-transporting substance) represented by the formula (CTM-2).

### Comparative Example 1-2

An electrophotographic photosensitive member of this comparative example was produced in the same manner as in Comparative Example 1-1 except that in Comparative Example 1-1, the organic compound-containing hydroxygallium phthalocyanine crystal obtained in Comparative Preparation Example 1 used in the preparation of the coating liquid for a charge-generating layer was changed to the organic compound-containing hydroxygallium phthalocyanine crystal obtained in Comparative Preparation Example 2.

### Comparative Example 1-3

An electrophotographic photosensitive member of this comparative example was produced in the same manner as in Example 1-1 except that in Example 1-1, the organic compound-containing hydroxygallium phthalocyanine crystal obtained in Preparation Example 1 used in the preparation of the coating liquid for a charge-generating layer was changed to the organic compound-containing hydroxygallium phthalocyanine crystal obtained in Comparative Preparation Example 1.

### Comparative Example 1-4

An electrophotographic photosensitive member of this comparative example was produced in the same manner as in Comparative Example 1-1 except that in Comparative Example 1-1, the organic compound-containing hydroxygallium phthalocyanine crystal obtained in Comparative Preparation Example 1 used in the preparation of the coating liquid for a charge-generating layer was changed to the organic compound-containing chlorogallium phthalocyanine crystal obtained in Preparation Example 9.

### Example 2-1

A solution containing the following components was subjected to dispersion treatment with a ball mill for 20 hours to prepare a coating liquid for a conductive layer.

| | | |
|---|---|---|
| Barium sulfate particles coated with tin oxide (trade | 60 | parts |
| name: Passtran PC1, manufactured by Mitsui Mining & | | |
| Smelting Co., Ltd.) | | |
| Titanium oxide particles (trade name: TITANIX JR, | 15 | parts |
| manufactured by Tayca Corporation) | | |
| Resole-type phenol resin (trade name: Phenolite J-325, | 43 | parts |
| manufactured by DIC Corporation, solid content: 70% by | | |
| mass) | | |
| Silicone oil (trade name: SH 28 PA, manufactured by Dow | 0.015 | part |
| Corning Toray Co., Ltd.) | | |
| Silicone resin (trade name: Tospearl 120, manufactured by | 3.6 | parts |
| Momentive Performance Materials Inc.) | | |
| 2-Methoxy-l-propanol | 50 | parts |
| Methanol | 50 | parts |

The coating liquid for a conductive layer was applied onto the outer peripheral surface of an aluminum cylinder as a support by immersion and then the resultant coating was dried for 30 minutes at 140° C. Thus, a conductive layer having a thickness of 15 μm was formed.

Next, 10 parts of a copolymer nylon resin (trade name: Amilan CM8000, manufactured by Toray Industries, Inc.) and 30 parts of a methoxymethylated 6-nylon resin (trade name: Toresin EF-30T, manufactured by Nagase ChemteX Corporation) were dissolved in a mixed solvent of 400 parts of methanol and 200 parts of n-butanol. Thus, a coating liquid for an undercoat layer was prepared.

The coating liquid for an undercoat layer was applied onto the conductive layer by immersion and then the resultant coating was dried. Thus, an undercoat layer having a thickness of 0.5 μm was formed.

Next, 10 parts of the organic compound-containing hydroxygallium phthalocyanine crystal (charge-generating substance) obtained in Preparation Example 1, 5 parts of polyvinyl butyral (trade name: S-LEC BX-1, manufactured by Sekisui Chemical Co., Ltd.), and 250 parts of cyclohexanone were loaded into a sand mill using glass beads each having a diameter of 1 mm, and were then subjected to dispersion treatment for 6 hours. The treated product was diluted with 250 parts of ethyl acetate. Thus, a coating liquid for a charge-generating layer was prepared.

The coating liquid for a charge-generating layer was applied onto the undercoat layer by immersion and then the resultant coating was dried for 10 minutes at 100° C. Thus, a charge-generating layer having a thickness of 0.18 μm was formed.

Next, the following components were dissolved in a mixed solvent of 70 parts of o-xylene and 20 parts of dimethoxymethane. Thus, a coating liquid for a charge-transporting layer was prepared.

| | | |
|---|---|---|
| Compound shown as Exemplified Compound (2-1) (charge- | 8 | parts |
| transporting substance) | | |
| Lubricant represented by the formula (PcSi-1) | 0.1 | part |
| Polycarbonate (trade name: Iupilon Z-200, manufactured by | 10 | parts |
| Mitsubishi Gas Chemical Company, Inc.) | | |

The coating liquid for a charge-transporting layer was applied onto the charge-generating layer by immersion and the resultant coating was dried for 1 hour at 125° C. Thus, a charge-transporting layer having a thickness of 22 μm was formed.

Thus, an electrophotographic photosensitive member of Example 2-1 having a cylindrical shape (drum-shape) was produced.

### Example 2-2

An electrophotographic photosensitive member of Example 2-2 was produced in the same manner as in Example 2-1 except that in Example 2-1, the organic compound-containing hydroxygallium phthalocyanine crystal obtained in Preparation Example 1 used in the preparation of the coating liquid for a charge-generating layer was changed to the organic compound-containing hydroxygallium phthalocyanine crystal obtained in Preparation Example 2, and Exemplified Compound (2-1) used in the preparation of the coating liquid for a charge-transporting layer was changed to Exemplified Compound (2-3).

### Example 2-3

An electrophotographic photosensitive member of Example 2-3 was produced in the same manner as in Example 2-1 except that in Example 2-1, the organic compound-containing hydroxygallium phthalocyanine crystal obtained in Preparation Example 1 used in the preparation of the coating liquid for a charge-generating layer was changed to the organic compound-containing hydroxygallium phthalocyanine crystal obtained in Preparation Example 3, and Exemplified Compound (2-1) used in the preparation of the coating liquid for a charge-transporting layer was changed to Exemplified Compound (2-10).

### Example 2-4

An electrophotographic photosensitive member of Example 2-4 was produced in the same manner as in Example 2-1 except that in Example 2-1, the organic compound-containing hydroxygallium phthalocyanine crystal obtained in Preparation Example 1 used in the preparation of the coating liquid for a charge-generating layer was changed to the organic compound-containing hydroxygallium phthalocyanine crystal obtained in Preparation Example 4, and Exemplified Compound (2-1) used in the preparation of the coating liquid for a charge-transporting layer was changed to Exemplified Compound (2-12).

### Example 2-5

An electrophotographic photosensitive member of Example 2-5 was produced in the same manner as in Example 2-4 except that in Example 2-4, 8 parts of Exemplified Compound (2-12) used in the preparation of the coating liquid for a charge-transporting layer was changed to 6 parts of Exemplified Compound (2-11) and 3 parts of the compound (charge-transporting substance) represented by the formula (CTM-1).

### Example 2-6

An electrophotographic photosensitive member of Example 2-6 was produced in the same manner as in Example 2-4 except that in Example 2-4, 8 parts of Exemplified Compound (2-12) used in the preparation of the coating liquid for a charge-transporting layer was changed to 5 parts of Exemplified Compound (2-16) and 3 parts of the compound (charge-transporting substance) represented by the formula (CTM-2).

### Example 2-7

An electrophotographic photosensitive member of Example 2-7 was produced in the same manner as in Example 2-1 except that in Example 2-1, the organic compound-containing hydroxygallium phthalocyanine crystal obtained in Preparation Example 1 used in the preparation of the coating liquid for a charge-generating layer was changed to the organic compound-containing hydroxygallium phthalocyanine crystal obtained in Preparation Example 5, and 8 parts of Exemplified Compound (2-1) used in the preparation of the coating liquid for a charge-transporting layer was changed to 4 parts of Exemplified Compound (2-16) and 4 parts of Exemplified Compound (2-23).

### Example 2-8

An electrophotographic photosensitive member of Example 2-8 was produced in the same manner as in Example 2-1 except that in Example 2-1, the organic compound-containing hydroxygallium phthalocyanine crystal obtained in Preparation Example 1 used in the preparation of the coating liquid for a charge-generating layer was changed to the organic compound-containing hydroxygallium phthalocyanine crystal obtained in Preparation Example 6, and Exemplified Compound (2-1) used in the preparation of the coating liquid for a charge-transporting layer was changed to Exemplified Compound (2-20).

### Example 2-9

An electrophotographic photosensitive member of Example 2-9 was produced in the same manner as in Example 2-1 except that in Example 2-1, the organic compound-containing hydroxygallium phthalocyanine crystal obtained in Preparation Example 1 used in the preparation of the coating liquid for a charge-generating layer was changed to the organic compound-containing hydroxygallium phthalocyanine crystal obtained in Preparation Example 7, and Exemplified Compound (2-1) used in the preparation of the coating liquid for a charge-transporting layer was changed to Exemplified Compound (2-18).

### Example 2-10

An electrophotographic photosensitive member of Example 2-10 was produced in the same manner as in Example 2-1 except that in Example 2-1, the organic compound-containing hydroxygallium phthalocyanine crystal obtained in Preparation Example 1 used in the preparation of the coating liquid for a charge-generating layer was changed to the organic compound-containing hydroxygallium phthalocyanine crystal obtained in Preparation Example 8, and Exemplified Compound (2-1) used in the preparation of the coating liquid for a charge-transporting layer was changed to Exemplified Compound (2-15).

### Example 2-11

An electrophotographic photosensitive member of Example 2-11 was produced in the same manner as in Example 2-1 except that in Example 2-1, the organic compound-containing hydroxygallium phthalocyanine crystal obtained in Preparation Example 1 used in the preparation of the coating liquid for a charge-generating layer was changed to the organic compound-containing chlorogallium phthalocyanine crystal obtained in Preparation Example 9.

### Example 2-12

An electrophotographic photosensitive member of Example 2-12 was produced in the same manner as in Example 2-1 except that in Example 2-1, the organic compound-containing hydroxygallium phthalocyanine crystal obtained in Preparation Example 1 used in the preparation of the coating liquid for a charge-generating layer was changed to the organic compound-containing chlorogallium phthalocyanine crystal obtained in Preparation Example 10, and Exemplified Compound (2-1) used in the preparation of the coating liquid for a charge-transporting layer was changed to Exemplified Compound (2-14).

### Comparative Example 2-1

An electrophotographic photosensitive member of Comparative Example 2-1 was produced in the same manner as in Example 2-1 except that in Example 2-1, the organic compound-containing hydroxygallium phthalocyanine crystal obtained in Preparation Example 1 used in the preparation of the coating liquid for a charge-generating layer was changed to the organic compound-containing hydroxygallium phthalocyanine crystal obtained in Comparative Preparation Example 1, and 8 parts of Exemplified Compound (2-1) used in the preparation of the coating liquid for a charge-transporting layer was changed to 4 parts of the compound (charge-transporting substance) represented by the formula (CTM-1) and 4 parts of the compound (charge-transporting substance) represented by the formula (CTM-2).

### Comparative Example 2-2

An electrophotographic photosensitive member of Comparative Example 2-2 was produced in the same manner as in Comparative Example 2-1 except that in Comparative Example 2-1, the organic compound-containing hydroxygallium phthalocyanine crystal obtained in Comparative Preparation Example 1 used in the preparation of the coating liquid for a charge-generating layer was changed to the organic compound-containing hydroxygallium phthalocyanine crystal obtained in Comparative Preparation Example 2.

### Comparative Example 2-3

An electrophotographic photosensitive member of Comparative Example 2-3 was produced in the same manner as in Example 2-1 except that in Example 2-1, the organic compound-containing hydroxygallium phthalocyanine crystal obtained in Preparation Example 1 used in the preparation of the coating liquid for a charge-generating layer was changed to the organic compound-containing hydroxygallium phthalocyanine crystal obtained in Comparative Preparation Example 1.

### Comparative Example 2-4

An electrophotographic photosensitive member of Comparative Example 2-4 was produced in the same manner as in Comparative Example 2-1 except that in Comparative Example 2-1, the organic compound-containing hydroxygallium phthalocyanine crystal obtained in Comparative Preparation Example 1 used in the preparation of the coating liquid for a charge-generating layer was changed to the organic compound-containing chlorogallium phthalocyanine crystal obtained in Preparation Example 9.

(Evaluation)

The electrophotographic photosensitive members produced above were each subjected to a ghost image evaluation.

Used as an electrophotographic apparatus for the evaluation was a laser beam printer manufactured by Hewlett-Packard Japan, Ltd. (trade name: Color Laser Jet CP3525dn) reconstructed as described below. That is, the printer was reconstructed so as to operate while pre-exposure was not turned on, and a charging condition and an image exposure value were variable. In addition, the printer was reconstructed so as to operate even when any one of the produced electrophotographic photosensitive members was mounted to a process cartridge for a cyan color and the cartridge was mounted to a station for the cyan process cartridge, and a process cartridge for any other color was not mounted to the main body of the printer.

Upon output of an image, only the process cartridge for a cyan color was mounted to the main body and a monochromatic image formed with a cyan toner alone was output.

First, under a normal-temperature and normal-humidity environment having a temperature of 23° C. and a relative humidity of 55% RH, the charging condition and the image exposure value were adjusted so that a dark portion potential and a light portion potential at an initial stage were −500 V and −100 V, respectively. The surface potential of the drum-shaped electrophotographic photosensitive member upon setting of an electric potential was measured as described below. The cartridge was reconstructed, a potential probe (trade name: model 6000B-8, manufactured by TREK JAPAN) was mounted at a development position, and an electric potential at the central portion of the cylindrical electrophotographic photosensitive member was then measured with a surface potentiometer (trade name: model 344, manufactured by TREK JAPAN).

After that, the ghost image evaluation was performed under the same conditions. After that, a 1,000-sheet repetitive sheet-passing test was performed, and the ghost image evaluation was performed immediately after the repetitive sheet-passing test and 15 hours after the repetitive sheet-passing test. The results of the evaluation under the normal-temperature and normal-humidity environment are shown in Table 1.

Next, the electrophotographic photosensitive member was left to stand under a low-temperature and low-humidity environment having a temperature of 15° C. and a relative humidity of 10% RH for 3 days together with the electrophotographic apparatus for the evaluation. After that, the ghost image evaluation was performed. Then, the 1,000-sheet repetitive sheet-passing test was performed under the same condition, and the ghost image evaluation was performed immediately after the repetitive sheet-passing test and 15 hours after the repetitive sheet-passing test. The results of the evaluation under the low-temperature and low-humidity environment are also shown in Table 1.

It should be noted that the repetitive sheet-passing test was performed under such a condition that an E-letter image was printed on A4-size plain paper at a print percentage of 1% with a cyan color alone.

In addition, a method for the ghost image evaluation is as described below.

The ghost image evaluation was performed with a total of eight ghost images output in the following order. A solid white image was output on the first sheet. After that, four kinds of ghost charts were each output on one sheet, i.e., were output on a total of four sheets. Next, a solid black image was output on one sheet. After that, the four kinds of ghost charts were each output on one sheet, i.e., were output on a total of four sheets again. The ghost charts to be classified into ranks were as described below. Four solid black squares 25 mm on a side were arranged at an equal interval and parallel to one another in a solid white background ranging from a print image starting position (10 mm from the upper end of paper) to a distance of 30 mm, and in a range distant from the print image starting position by more than 30 mm, four kinds of halftone print patterns were output.

The four kinds of ghost charts are charts different from one another only in halftone pattern in the range distant from the print image starting position by more than 30 mm, and the halftone patterns are the following four kinds:

(1) a print (laser exposure) pattern in which one dot is laterally* printed every other space;

(2) a print (laser exposure) pattern in which two dots are laterally* printed every two spaces;

(3) a print (laser exposure) pattern in which two dots are laterally* printed every three spaces; and *: The term “laterally” refers to the scanning direction of a laser scanner (the horizontal direction in output paper).

(4) a print (laser exposure) pattern of a knight pattern (a pattern in which two dots are printed on six squares like the movement of a knight in Japanese chess).

The ghost images were classified into ranks as described below. It should be noted that it was judged that the effect of the present invention was not sufficiently obtained at each of the ranks 4, 5, and 6.

Rank 1: No ghost is observed in each ghost chart.

Rank 2: A ghost is slightly observed in a specific ghost chart.

Rank 3: A ghost is slightly observed in each ghost chart.

Rank 4: A ghost is observed in a specific ghost chart.

Rank 5: A ghost is observed in each ghost chart.

Rank 6: A ghost is clearly observed in a specific ghost chart.

TABLE 1
Results of ghost image evaluation

| | Under normal-temperature and | | | Under low-temperature and | | |
|---|---|---|---|---|---|---|
| | ormal-humidity environment | | | low-humidity environment | | |
| | | Immediately after | 15 Hours after | | Immediately after | 15 Hours after |
| | Initial | repetitive sheet- | repetitive sheet- | Initial | repetitive sheet- | repetitive sheet- |
| | stage | passing test | passing test | stage | passing test | passing test |
| Example No. | Ghost rank | Ghost rank | Ghost rank | Ghost rank | Ghost rank | Ghost rank |
| Example 1-1 | 1 | 2 | 2 | 2 | 2 | 2 |
| Example 1-2 | 1 | 1 | 1 | 2 | 2 | 2 |
| Example 1-3 | 1 | 2 | 1 | 2 | 3 | 2 |
| Example 1-4 | 1 | 2 | 1 | 1 | 2 | 2 |
| Example 1-5 | 1 | 2 | 2 | 2 | 2 | 2 |
| Example 1-6 | 1 | 2 | 1 | 1 | 2 | 2 |
| Example 1-7 | 1 | 1 | 1 | 1 | 2 | 2 |
| Example 1-8 | 1 | 2 | 2 | 2 | 2 | 3 |
| Example 1-9 | 1 | 2 | 2 | 2 | 3 | 3 |
| Example 1-10 | 1 | 2 | 2 | 2 | 3 | 2 |
| Example 1-11 | 1 | 2 | 2 | 2 | 3 | 2 |
| Example 1-12 | 1 | 2 | 2 | 2 | 3 | 3 |
| Comparative Example 1-1 | 4 | 5 | 4 | 5 | 6 | 5 |
| Comparative Example 1-2 | 4 | 5 | 5 | 5 | 6 | 6 |
| Comparative Example 1-3 | 4 | 4 | 4 | 5 | 6 | 5 |
| Comparative Example 1-4 | 2 | 3 | 3 | 3 | 4 | 4 |
| Example 2-1 | 1 | 2 | 1 | 2 | 2 | 2 |
| Example 2-2 | 1 | 2 | 2 | 2 | 3 | 2 |
| Example 2-3 | 1 | 2 | 2 | 2 | 3 | 2 |
| Example 2-4 | 1 | 2 | 1 | 1 | 2 | 2 |
| Example 2-5 | 2 | 2 | 2 | 2 | 3 | 2 |
| Example 2-6 | 1 | 1 | 1 | 1 | 2 | 1 |
| Example 2-7 | 1 | 2 | 1 | 1 | 2 | 2 |
| Example 2-8 | 1 | 2 | 2 | 2 | 3 | 2 |
| Example 2-9 | 2 | 2 | 2 | 2 | 3 | 3 |
| Example 2-10 | 1 | 2 | 2 | 2 | 3 | 3 |
| Example 2-11 | 1 | 2 | 1 | 1 | 2 | 2 |
| Example 2-12 | 1 | 2 | 2 | 2 | 3 | 3 |
| Comparative Example 2-1 | 4 | 5 | 4 | 5 | 6 | 5 |
| Comparative Example 2-2 | 4 | 5 | 5 | 5 | 6 | 6 |
| Comparative Example 2-3 | 3 | 4 | 4 | 5 | 6 | 5 |
| Comparative Example 2-4 | 2 | 3 | 3 | 3 | 4 | 4 |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-228873, filed Nov. 11, 2014, and Japanese Patent Application No. 2014-234937, filed Nov. 19, 2014, which are hereby incorporated by reference herein in their entirety.

What is claimed is:

1. An electrophotographic photosensitive member, comprising in the following order:
a support;
a charge-generating layer; and
a charge-transporting layer, wherein:
the charge-generating layer comprises a gallium phthalocyanine crystal in which an organic compound is contained;
the organic compound is at least one compound selected from the group consisting of dimethyl sulfoxide, N,N-dimethylformamide, N-methylformamide, N-propylformamide, N-vinylformamide, and N-methylpyrrolidone;
a content of the organic compound is 0.1% by mass or more and 1.5% by mass or less with respect to a mass of gallium phthalocyanine in the gallium phthalocyanine crystal; and
the charge-transporting layer comprises at least one compound selected from the group consisting of a compound represented by the formula (1), a compound represented by the formula (2), a compound represented by the formula (3), and a compound represented by the formula (4): 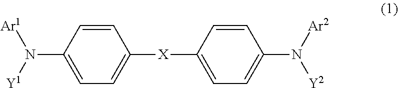
in the formula (1):
Ar¹ and Ar² each independently represent a substituted or unsubstituted phenyl group;
X represents a phenylene group;
Y¹ and Y² each independently represent a substituted or unsubstituted phenyl group, a substituted or unsubstituted benzyl group, a 9,9-dimethyl-9H-fluoren-2-yl group, or a group represented by the following formula (A);
a substituent of the substituted phenyl group is an alkyl group having 1 to 4 carbon atoms, a methoxy group, an ethoxy group, a dimethylamino group, a diethylamino group, or a phenyl group; and
a substituent of the substituted benzyl group is a methyl group or an ethyl group, 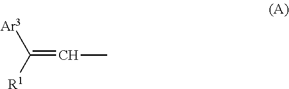
in the formula (A):
Ar³ represents a substituted or unsubstituted phenyl group;
a substituent of the substituted phenyl group is an alkyl group having 1 to 4 carbon atoms, a methoxy group, an ethoxy group, a dimethylamino group, a diethylamino group, or a phenyl group;
R¹ represents a substituted or unsubstituted alkyl group having 1 to 3 carbon atoms; and
a substituent of the substituted alkyl group is an alkyl group having 1 to 4 carbon atoms, a methoxy group, an ethoxy group, a dimethylamino group, a diethylamino group, or a phenyl group, 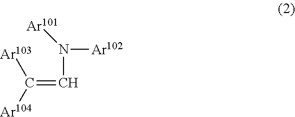
in the formula (2):
Ar¹⁰¹ to Ar¹⁰⁴ each independently represent a substituted or unsubstituted aryl group, 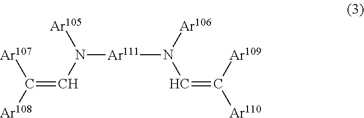
in the formula (3):
Ar¹⁰⁵ to Ar¹¹⁰ each independently represent a substituted or unsubstituted aryl group; and
Ar¹¹¹ represents a phenylene group or a 4,4′-biphenyldiyl group, 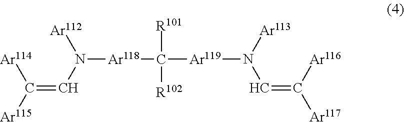
in the formula (4):
Ar¹¹² to Ar¹¹⁷ each independently represent a substituted or unsubstituted aryl group;
Ar¹¹⁸ and Ar¹¹⁹ each independently represent a phenylene group or a 4,4′-biphenyldiyl group; and
R¹⁰¹ and R¹⁰² each independently represent an alkyl group or a phenyl group, or R¹⁰¹ and R¹⁰² represent groups necessary for forming a ring structure by being bonded to each other together with a carbon atom to which R¹⁰¹ and R¹⁰² are bonded.

2. An electrophotographic photosensitive member according to claim 1, wherein a content of the organic compound is 0.4% by mass or more and 1.4% by mass or less with respect to a mass of gallium phthalocyanine in the gallium phthalocyanine crystal.

3. An electrophotographic photosensitive member according to claim 1, wherein the organic compound is at least one compound selected from the group consisting of N-methylformamide, N-propylformamide, and N-vinylformamide.

4. An electrophotographic photosensitive member according to claim 1, wherein Y¹ in the formula (1) represents a 9,9-dimethyl-9H-fluoren-2-yl group.

5. An electrophotographic photosensitive member according to claim 4, wherein Y¹ and Y² in the formula (1) each represent a 9,9-dimethyl-9H-fluoren-2-yl group.

6. An electrophotographic photosensitive member according to claim 1, wherein Ar¹ and Ar² in the formula (1) each represent a tolyl group.

7. An electrophotographic photosensitive member according to claim 1, wherein at least one of Ar¹⁰¹ to Ar¹⁰⁴, at least one of Ar¹⁰⁵ to Ar¹¹⁰, and at least one of Ar¹¹² to Ar¹¹⁷ in the formulae (2) to (4) each represent a 9,9-dimethyl-9H-fluoren-2-yl group.

8. An electrophotographic photosensitive member according to claim 7, wherein Ar¹⁰⁵ and Ar¹⁰⁶ in the formula (3) each represent a 9,9-dimethyl-9H-fluoren-2-yl group.

9. An electrophotographic photosensitive member according to claim 7, wherein Ar¹¹² and Ar¹¹³ in the formula (4) each represent a 9,9-dimethyl-9H-fluoren-2-yl group and R¹⁰¹ and R¹⁰² in the formula (4) each represent a methyl group.

10. An electrophotographic photosensitive member according to claim 1, wherein the gallium phthalocyanine crystal is a hydroxygallium phthalocyanine crystal.

11. An electrophotographic photosensitive member according to claim 1, wherein the gallium phthalocyanine crystal is a chlorogallium phthalocyanine crystal.

12. A process cartridge, which integrally supports an electrophotographic photosensitive member and at least one device selected from the group consisting of a charging device, a developing device, a transferring device and a cleaning device, and is detachably mountable to a main body of an electrophotographic apparatus, wherein:
the electrophotographic photosensitive member comprises in the following order:
a support;
a charge-generating layer; and
a charge-transporting layer,
the charge-generating layer comprises a gallium phthalocyanine crystal in which an organic compound is contained;
the organic compound is at least one compound selected from the group consisting of dimethyl sulfoxide, N,N-dimethylformamide, N-methylformamide, N-propylformamide, N-vinylformamide, and N-methylpyrrolidone;
a content of the organic compound is 0.1% by mass or more and 1.5% by mass or less with respect to a mass of gallium phthalocyanine in the gallium phthalocyanine crystal; and
the charge-transporting layer comprises at least one compound selected from the group consisting of a compound represented by the formula (1), a compound represented by the formula (2), a compound represented by the formula (3), and a compound represented by the formula (4): 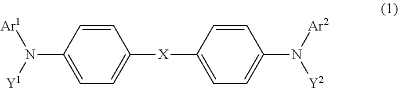
in the formula (1):
Ar¹ and Ar² each independently represent a substituted or unsubstituted phenyl group;
X represents a phenylene group;
Y¹ and Y² each independently represent a substituted or unsubstituted phenyl group, a substituted or unsubstituted benzyl group, a 9,9-dimethyl-9H-fluoren-2-yl group, or a group represented by the following formula (A);
a substituent of the substituted phenyl group is an alkyl group having 1 to 4 carbon atoms, a methoxy group, an ethoxy group, a dimethylamino group, a diethylamino group, or a phenyl group; and
a substituent of the substituted benzyl group is a methyl group or an ethyl group, 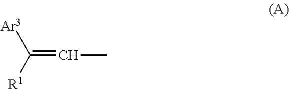
in the formula (A):
Ar³ represents a substituted or unsubstituted phenyl group;
a substituent of the substituted phenyl group is an alkyl group having 1 to 4 carbon atoms, a methoxy group, an ethoxy group, a dimethylamino group, a diethylamino group, or a phenyl group;
R¹ represents a substituted or unsubstituted alkyl group having 1 to 3 carbon atoms; and
a substituent of the substituted alkyl group is an alkyl group having 1 to 4 carbon atoms, a methoxy group, an ethoxy group, a dimethylamino group, a diethylamino group, or a phenyl group, 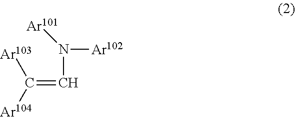
in the formula (2):
Ar¹⁰¹ to Ar¹⁰⁴ each independently represent a substituted or unsubstituted aryl group, 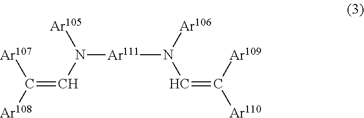
in the formula (3):
Ar¹⁰⁵ to Ar¹¹⁰ each independently represent a substituted or unsubstituted aryl group; and
Ar¹¹¹ represents a phenylene group or a 4,4′-biphenyldiyl group, 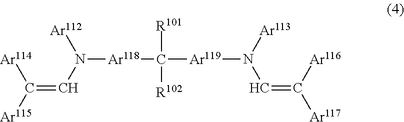
in the formula (4):
Ar¹¹² to Ar¹¹⁷ each independently represent a substituted or unsubstituted aryl group;
Ar¹¹⁸ and Ar¹¹⁹ each independently represent a phenylene group or a 4,4′-biphenyldiyl group; and
R¹⁰¹ and R¹⁰² each independently represent an alkyl group or a phenyl group, or R¹⁰¹ and R¹⁰² represent groups necessary for forming a ring structure by being bonded to each other together with a carbon atom to which R¹⁰¹ and R¹⁰² are bonded.

13. An electrophotographic apparatus, comprising:
an electrophotographic photosensitive member;
a charging device;
an exposing device;
a developing device; and
a transferring device, wherein:
the electrophotographic photosensitive member comprises in the following order:
a support;
a charge-generating layer; and
a charge-transporting layer,
the charge-generating layer comprises a gallium phthalocyanine crystal in which an organic compound is contained;
the organic compound is at least one compound selected from the group consisting of dimethyl sulfoxide, N,N-dimethylformamide, N-methylformamide, N-propylformamide, N-vinylformamide, and N-methylpyrrolidone;
a content of the organic compound is 0.1% by mass or more and 1.5% by mass or less with respect to a mass of gallium phthalocyanine in the gallium phthalocyanine crystal; and
the charge-transporting layer comprises at least one compound selected from the group consisting of a compound represented by the formula (1), a compound represented by the formula (2), a compound represented by the formula (3), and a compound represented by the formula (4): 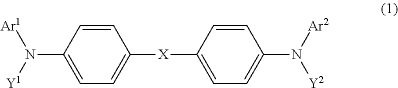
in the formula (1):
Ar¹ and Ar² each independently represent a substituted or unsubstituted phenyl group;
X represents a phenylene group;
Y¹ and Y² each independently represent a substituted or unsubstituted phenyl group, a substituted or unsubstituted benzyl group, a 9,9-dimethyl-9H-fluoren-2-yl group, or a group represented by the following formula (A);
a substituent of the substituted phenyl group is an alkyl group having 1 to 4 carbon atoms, a methoxy group, an ethoxy group, a dimethylamino group, a diethylamino group, or a phenyl group; and
a substituent of the substituted benzyl group is a methyl group or an ethyl group, 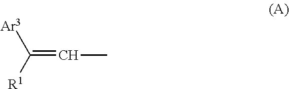
in the formula (A):
Ar³ represents a substituted or unsubstituted phenyl group;
a substituent of the substituted phenyl group is an alkyl group having 1 to 4 carbon atoms, a methoxy group, an ethoxy group, a dimethylamino group, a diethylamino group, or a phenyl group;
R¹ represents a substituted or unsubstituted alkyl group having 1 to 3 carbon atoms; and
a substituent of the substituted alkyl group is an alkyl group having 1 to 4 carbon atoms, a methoxy group, an ethoxy group, a dimethylamino group, a diethylamino group, or a phenyl group, 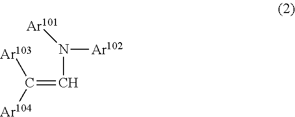
in the formula (2):
Ar¹⁰¹ to Ar¹⁰⁴ each independently represent a substituted or unsubstituted aryl group, 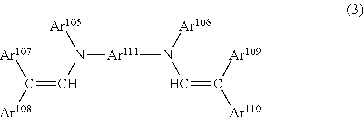
in the formula (3):
Ar¹⁰⁵ to Ar¹¹⁰ each independently represent a substituted or unsubstituted aryl group; and
Ar¹¹¹ represents a phenylene group or a 4,4′-biphenyldiyl group, 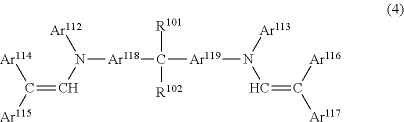
in the formula (4):
Ar¹¹² to Ar¹¹⁷ each independently represent a substituted or unsubstituted aryl group;
Ar¹¹⁸ and Ar¹¹⁹ each independently represent a phenylene group or a 4,4′-biphenyldiyl group; and
R¹⁰¹ and R¹⁰² each independently represent an alkyl group or a phenyl group, or R¹⁰¹ and R¹⁰² represent groups necessary for forming a ring structure by being bonded to each other together with a carbon atom to which R¹⁰¹ and R¹⁰² are bonded.
